(19) United States
(12) Patent Application Publication
(10) Pub. No.: US 2009/0098961 A1
(43) Pub. Date: Apr. 16, 2009

(54) Internal Combustion Engine, Vehicle Power Transmission System and Lawn Tractor Equipped With Them

(76) Inventors: Toshiyuki Hasegawa, Amagasaki-shi (JP); Koji Iwaki, Amagasaki-sh i (JP); Hiroaki Shimizu, Amagasaki-shi (JP)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 11/871,588

(22) Filed: Oct. 12, 2007

(51) Int. Cl. F16H 7/00

(52) U.S. Cl. 474/61

(57) ABSTRACT

An internal combustion engine comprises: a crankshaft; an oil pan; and an output shaft supported by the oil pan. The output shaft is disposed perpendicular to the crankshaft, and is drivingly connected to the crankshaft.

### BACKGROUND OF THE INVENTION

1. Field of the Invention

The present invention relates to an internal combustion engine and a power transmission system for a working vehicle, such as a lawn tractor, equipped with the internal combustion engine.

2. Related Art

Conventional hydraulic drive working vehicles are often equipped with an upright internal combustion engine serving as a prime mover, and with a power transmission system extending from an end of a vertical crankshaft of the internal combustion engine. For example, in a working vehicle disclosed by U.S. Pat. No. 6,732,828, a projecting end of a vertical crankshaft is drivingly connected to a hydraulic pump serving as an element of a transaxle, and a belt transmission is extended from the crankshaft so as to transmit power to a working device equipped on the vehicle.

The arrangement of the upright internal combustion engine is often employed by small-sized working vehicles each having vertical input shafts of a hydraulic pump and a working device. The belt-and-pulleys assembly is used to simply and easily connect the power transmission system from the vertical output shaft of the internal combustion engine to the input shafts of the hydraulic pump and the working vehicle. However, use of an upright internal combustion engine does have drawbacks. For example, because the upright combustion engine has a horizontal piston (or horizontal pistons) for driving the vertical crankshaft so as to cause eccentric abrasion of a piston cylinder, which leads to axial deviation of the crankshaft, this system causes vibration, noise, and an overall reduction in the life of the internal combustion engine.

Internal combustion engines are commonly configured with a horizontal crankshaft. It would be desirable to configure a power transmission system so that it is entirely disposed in the inside of a vehicle frame, so as to ensure compactness and good appearance of the vehicle. However, with regard to the configuration of a power transmission system extending from the projecting end of a horizontal crankshaft, the arrangement of the components of a working device (e.g., a mower and a mower duct, if the vehicle is a lawn tractor) must be considered so as to ensure a proper layout of the entire power transmission system in the inside of the vehicle frame. Japanese Laid-open Gazette No. 2006-321339 teaches a working vehicle with an improved layout of the power transmission system in light of these concerns.

In this working vehicle, an internal combustion engine has a horizontal crankshaft, a hydraulic pump has a horizontally forward projecting pump shaft, and a propeller shaft with universal joints connects a projecting end of the crankshaft to the pump shaft. Due to this arrangement, the power transmission system can be disposed within the limited inside of the vehicle frame without interfering with the working device and without hindering attachment or detachment to it.

However, the larger the axial deviation between the crankshaft end of the internal combustion engine and the pump shaft of the hydraulic pump is, the larger the slant angle of the propeller shaft becomes, so as to reduce its power transmission efficiency. In addition, in a vehicle equipped with various implements, it is difficult to coaxially dispose the crankshaft end and the pump shaft. In the case where the vehicle is provided with a transaxle and the working device includes respective vertical input shafts, a PTO pulley is provided on the horizontal crankshaft end, and a belt looped over the PTO pulley is usually twisted by counter pulleys having rotary axes perpendicular to the crankshaft axis, so as to drivingly connect the horizontal crankshaft end to the vertical input shafts. In this arrangement, the belt is extended rearward to the input shaft so that intermediate portions of the belt cross a front axle having a front wheel thereon. Because the front transaxle is tiltably centered on a center pin so as to follow the ground surface, a large space must be provided above the front transaxle so as to pass the belt above the front transaxle without interfering with the tilted front transaxle, thereby disturbing minimization of the vehicle. Alternatively, if the PTO pulley is not provided on a front end of the crankshaft, but it is provided on a rear end of the crankshaft, the belt extending from the rear end of the crankshaft can be twisted without crossing the front axle. However, if the working device is suspended between front and rear wheels, the input shaft of the working device must be very close to the input shaft of the working device, so the belt would have to be tilted at a very large angle to ensure free vertical movement of the working device. Thus, the PTO pulley provided on the rear crankshaft end is also impractical.

### SUMMARY OF THE INVENTION

A first object of the present invention is to provide a compact internal combustion engine which can be disposed axially horizontally so as to enable output to a drive target having an input shaft end disposed perpendicular to the crankshaft.

To achieve the first object, an internal combustion engine according to the present invention comprises a crankshaft, an oil pan and an output shaft. The oil pan supports the output shaft. The output shaft is disposed perpendicular to the crankshaft and is drivingly connected to the crankshaft. Therefore, a main part of the internal combustion engine is constructed as a horizontal crankshaft combustion engine, however, due to the small-scaled modification of surroundings of the oil pan, the internal combustion engine can effectively output power to a drive target having an input shaft end disposed perpendicular to the crankshaft. For example, even if the internal combustion engine is mounted on a vehicle so as to extend the crankshaft horizontally, the internal combustion engine can output power to a vertical input shaft of a drive target, such as a hydraulic pump of a transaxle of a working device, in the same manner as a vertical crankshaft internal combustion engine. Since the oil pan supports the output shaft, the internal combustion engine is kept compact so as to ensure plenty of space around the internal combustion engine. An engine maker familiar with this type of internal combustion engine could easily make an internal combustion engine into either a horizontal output type or a vertical output type.

Preferably, the output shaft is disposed within a plane of projection of the internal combustion engine when viewed in plan. Therefore, the internal combustion engine can be compacted horizontally.

Preferably, a housing incorporating the output shaft is provided in the oil pan. Accordingly, the portion of the output shaft projecting outward from the internal combustion engine is minimized. In the oil pan, the inside of the housing serves as a sufficiently large space for including a drive connection structure connecting the output shaft to the crankshaft. Furthermore, lube in the housing for the output shaft can be separated from lube in the oil pan for the internal combustion engine outside of the housing.

Preferably, the internal combustion engine further comprises an input shaft for transmitting power from the crankshaft to the output shaft. The input shaft is disposed parallel to the crankshaft and is drivingly connected to the output shaft in the oil pan. Therefore, even if the output shaft is distant from the crankshaft, the input shaft drivingly connects the output shaft to the crankshaft. The input shaft parallel to the crankshaft can be easily drivingly connected to the crankshaft through an endless band transmission including a belt or a chain. Further, the drive connection of the input shaft to the output shaft is provided in the oil pan so as not to be exposed outside of the internal combustion engine, thereby ensuring the compactness of the internal combustion engine and ensuring a large free space around the internal combustion engine.

Preferably, the input shaft includes a portion projecting outward from the oil pan such as to be drivingly connected to the crankshaft. Accordingly, the compactness of the internal combustion engine itself can be ensured. Further preferably, a cooling fan is provided on the projecting portion of the input shaft. Because of this simple structure, the oil pan can be cooled so as to efficiently cool the power transmission mechanism, including the input shaft and the output shaft, disposed in the oil pan.

Preferably, the internal combustion engine is provided with an endless band transmission for drivingly connecting the input shaft to the crankshaft. Since the input shaft is disposed parallel to the crankshaft, the simple endless band transmission, such as a belt transmission or a chain transmission, can drivingly connect the input shaft to the crankshaft, thereby reducing costs and improving assembly.

Preferably, the internal combustion engine includes a housing in the oil pan. The housing incorporates the output shaft, and the input shaft is inserted into the housing so as to be drivingly connected to the output shaft. In this way, the mechanism drivingly connecting the input shaft to the output shaft is not exposed outside of the internal combustion engine, thereby ensuring the compactness of the internal combustion engine and ensuring a large free space around the internal combustion engine. Further, lube in the housing for a drive connection structure such as a gear train can be separated from lube in the oil pan outside of the housing so as to ensure the long life of appropriate power transmission efficiency between the input shaft and the output shaft.

Alternatively, the internal combustion engine preferably includes first and second gears. The first gear is provided on the crankshaft, and the second gear is provided on the output shaft so as to mesh with the first gear. Therefore, no additional shaft for transmitting power from the crankshaft to the output shaft is required, and no shaft end in addition to the crankshaft end and the output shaft end projects outward from the internal combustion engine, thereby further ensuring the compactness of the internal combustion engine.

Preferably, in the internal combustion engine, an output member for outputting power of the output shaft to a drive target is provided on a portion of the output shaft projecting outward from the oil pan. Therefore, the internal combustion engine can be provided as a very convenient internal combustion engine which can simply output power from the output member to a drive target that has an input shaft end disposed perpendicular to the crankshaft.

Preferably, the internal combustion engine includes a clutch interposed between the output member and the output shaft. Therefore, power can be selectively transmitted or cut off to and from the drive target according to operation of the clutch. The clutch enhances the convenience of the internal combustion engine.

Preferably, the internal combustion engine includes a second output shaft capable of receiving power from the foresaid output shaft. Therefore, even if the drive target is too difficult in layout or structure to be drivingly connected to the first output member on the first output shaft supported by the oil pan, the drive target can still be easily drivingly connected to the second output member on the second shaft, thereby being easily drivingly connected to the first output member on the first output shaft supported by the oil pan.

Preferably, the internal combustion engine includes a clutch interposed between the second output shaft and the second output member. Therefore, power can be selectively transmitted or cut off to and from the drive target according to operation of the clutch. The clutch can be distant from the internal combustion engine so as to facilitate handling, attachment and detachment thereof.

Preferably, in the internal combustion engine, the output shaft includes a portion projecting outward from the oil pan. First and second output members are provided on the projecting portion of the output shaft so as to distribute power from the output shaft to respective drive targets. Due to the drive connection of the first and second output members to the respective drive targets, the internal combustion engine having the single output shaft is able to output power from the common output shaft to the plural drive targets.

Preferably, the internal combustion engine includes a clutch interposed between the output shaft and at least one of the first and second output members. Therefore, the internal combustion engine having the single output shaft, which can distribute power from the common output shaft to the plural drive targets, is enabled to selectively transmit or cut off to and from at least one of the drive targets.

A second object of the present invention is to provide a compact and simple power transmission system for a vehicle equipped with an internal combustion engine having a substantially horizontal crankshaft and with a drive target having a vertical input shaft end. The power transmission system is provided for outputting power from the crankshaft to the drive target.

To achieve the second object, a vehicle power transmission system according to the present invention comprises an internal combustion engine and a rotary member. The internal combustion engine includes an oil pan, and is mounted on the vehicle so as to have a substantially horizontal crankshaft. The rotary member is provided for transmitting power from the crankshaft to a drive target. The rotary member is supported by the oil pan, is rotatably centered on a vertical axis, and is drivingly connected to the crankshaft.

Therefore, in the vehicle, the power transmission system can output power to a drive target, such as a hydraulic pump of a transaxle or a working device, having a vertical input shaft disposed perpendicular to the substantially horizontal crankshaft of the internal combustion engine. Furthermore, the power transmission system uses the oil pan of the internal combustion engine to serve as a support of the rotary member, thereby ensuring the compactness of the internal combustion engine and ensuring a large free space around the internal combustion engine.

Preferably, the rotary member includes first and second output members. The first output member is drivingly connected to a first drive target. The second output member is drivingly connected to a second drive target. Therefore, for example, a transaxle including a vertical input shaft serves as the first drive target, and a working device including a vertical input shaft serves as the second drive target. In this case, the power transmission system can easily drivingly connect the substantially horizontal crankshaft of the internal combustion engine to both the drive targets.

Preferably, the internal combustion engine includes a flywheel provided on an end portion of the crankshaft. A second rotary member is provided on the flywheel. The first rotary member supported by the oil pan is drivingly connected to a first drive target, and the second rotary member is drivingly connected to a second drive target. Therefore, if the layout or structure of the second drive target makes it too difficult to drivingly connected it to the first rotary member on the first output shaft supported by the oil pan, the second drive target can be easily drivingly connected to the second rotary member. Because the flywheel serves as a support member supporting the second rotary member, the second rotary member can use the axis of the crankshaft as the rotary axis thereof. Therefore, the second rotary member coaxial to the crankshaft is used for outputting power in addition to the rotary member supported by the oil pan being used for outputting power perpendicular to the crankshaft. Consequently, the two rotary members are convenient for outputting respective powers to plural drive targets appropriately with regard to the respective rotation directions and positions.

A third object of the present invention is to provide a lawn tractor equipped with a compact and simple power transmission system for outputting power from a crankshaft of an internal combusting engine to a transaxle and a mower. The internal combustion engine is mounted on a vehicle frame so as to extend the crankshaft substantially horizontally. The transaxle and the mower include respective vertical input shaft ends.

To achieve the third object, a lawn tractor according to the present invention comprises an internal combustion engine and a rotary member. The internal combustion engine includes an oil pan, and is mounted on a vehicle frame so as to extend a crankshaft substantially horizontally. The rotary member is provided for transmitting power from the crankshaft to a drive target. The rotary member is supported by the oil pan, is rotatably centered on a vertical axis, and is drivingly connected to the crankshaft.

Therefore, in the vehicle, the power transmission system can efficiently output power to a drive target, such as a hydraulic pump of a transaxle or a mower, having a vertical input shaft disposed perpendicular to the substantially horizontal crankshaft. The power transmission system includes the rotary member, and uses the oil pan of the internal combustion engine to support the rotary member, thereby ensuring the compactness of the internal combustion engine and ensuring a large free space around the internal combustion engine.

Preferably, the rotary member includes first and second output members. The first output member is drivingly connected to a first drive target. The second output member is drivingly connected to a second drive target. Therefore, for example, a transaxle including a vertical input shaft serves as the first drive target, and a working device including a vertical input shaft serves as the second drive target. In this case, the power transmission system can easily drivingly connect the substantially horizontal crankshaft of the internal combustion engine to both the drive targets.

Preferably, the internal combustion engine includes a flywheel provided on an end portion of the crankshaft. A second rotary member is provided on the flywheel. The first rotary member supported by the oil pan is drivingly connected to the first drive target, and the second rotary member is drivingly connected to the second drive target. Therefore, if the layout or structure of the second drive target makes it too difficult to be drivingly connected to the first rotary member on the first output shaft supported by the oil pan, the second drive target can be easily drivingly connected to the second rotary member. Since the flywheel serves as a support member supporting the second rotary member, the second rotary member can use the axis of the crankshaft as the rotary axis thereof. Therefore, the second rotary member coaxial to the crankshaft is used for outputting power in addition to the rotary member supported by the oil pan being used for outputting power perpendicular to the crankshaft. Consequently, the two rotary members are convenient for outputting respective powers to plural drive targets, i.e., the transaxle and the mower, appropriately with regard to the respective rotation directions and positions.

These, other and further objects, features and advantages of the present invention will appear more fully from the following description with reference to accompanying drawings.

### BRIEF DESCRIPTION OF THE DRAWINGS

FIG. 1 is a sectional side view of a lawn tractor equipped with an internal combustion engine (or a power transmission system) according to a first embodiment.

FIG. 2 is a side view of the entire internal combustion engine according to the first embodiment.

FIG. 3 is a fragmentary sectional side view of the internal combustion engine according to the first embodiment.

FIG. 4 is a fragmentary front view of the internal combustion engine according to the first embodiment.

FIG. 5 is a fragmentary sectional side view of an internal combustion engine according to a second embodiment.

FIG. 6 is a fragmentary sectional side view of an internal combustion engine according to a third embodiment.

FIG. 7 is a fragmentary sectional side view of an internal combustion engine according to a fourth embodiment.

FIG. 8 is a fragmentary sectional side view of an internal combustion engine according to a fifth embodiment.

FIG. 9 is a fragmentary sectional side view of an internal combustion engine according to a sixth first embodiment.

FIG. 10 is a fragmentary sectional side view of an internal combustion engine according to a seventh embodiment.

FIG. 11 is a fragmentary sectional side view of an internal combustion engine according to an eighth embodiment.

FIG. 12 is a fragmentary sectional side view of an internal combustion engine according to a ninth embodiment.

FIG. 13 is a fragmentary sectional side view of an internal combustion engine according to a tenth embodiment.

FIG. 14 is a fragmentary front view of the internal combustion engine according to the tenth embodiment.

FIG. 15 is a fragmentary sectional side view of an internal combustion engine according to an eleventh first embodiment.

FIG. 16 is a side view partly in section of the internal combustion engine according to the eleventh embodiment when a hydraulic pump is disposed at another position.

FIG. 17 is a fragmentary sectional side view of an internal combustion engine according to a twelfth embodiment.

FIG. 18 is a sectional side view of a lawn tractor equipped with the internal combustion engine according to the second embodiment.

FIG. 19 is a sectional side view of a lawn tractor equipped with the internal combustion engine according to the third embodiment.

FIG. 20 is a sectional side view of a lawn tractor equipped with the internal combustion engine according to the fourth embodiment.

### DETAILED DESCRIPTION OF THE INVENTION

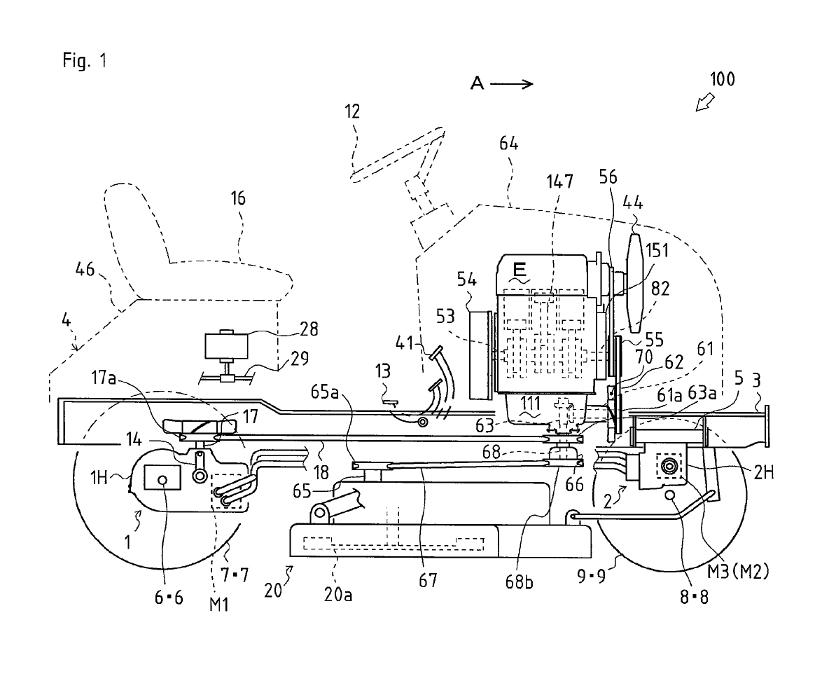

A vehicle 100 equipped with an internal combustion engine E according to a first embodiment will be described with reference to FIG. 1. An arrow A is pointed forward, and left and right directions are defined on the assumption that the arrow A is directed forward. The disclosed direction of internal combustion engine E is not limitative. A flywheel 54 may be fore-and-aft reversed. If a laterally wide frame constitutes the vehicle body, internal combustion engine E may be disposed so as to axially extend its crankshaft along the lateral width direction of the vehicle.

Vehicle 100 is an Ackerman-type steering lawn machine (lawn tractor). Vehicle 100 is provided with a vehicle frame 3, a rear transaxle 1, a front transaxle 2, internal combustion engine E and a mower 20. Rear transaxle 1 is supported by a rear portion of vehicle frame 3, and front transaxle 2 is supported by a front portion of vehicle frame 3. Internal combustion engine E is supported by vehicle frame 3 between transaxles 1 and 2. Mower 20, serving as an example of a working device driven by internal combustion engine E, is vertically and movably suspended downward from vehicle frame 3.

Vehicle frame 3 includes a pair of left and right side plates extended in the substantially fore-and-aft direction of vehicle 100. Rear transaxle 1 is disposed in the inside of vehicle frame 3, i.e., between the left and right side plates.

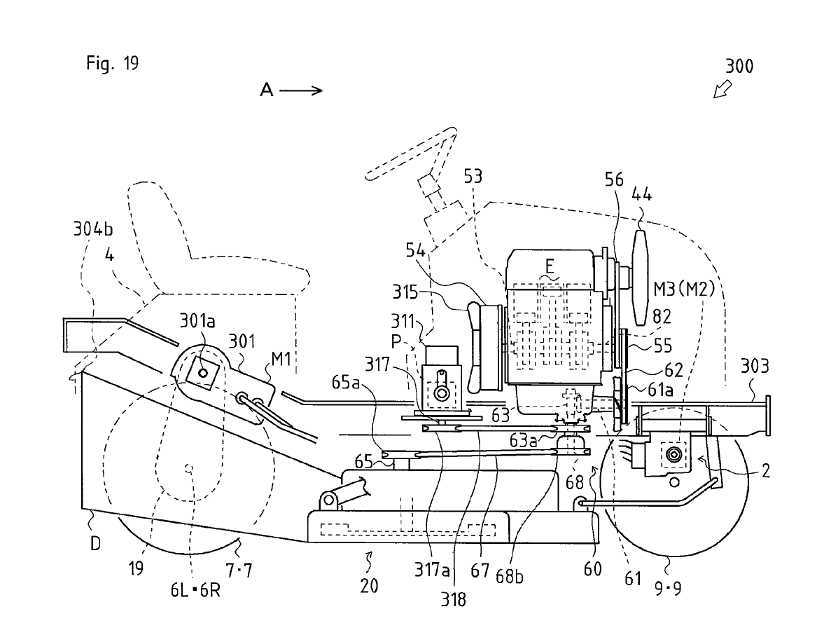

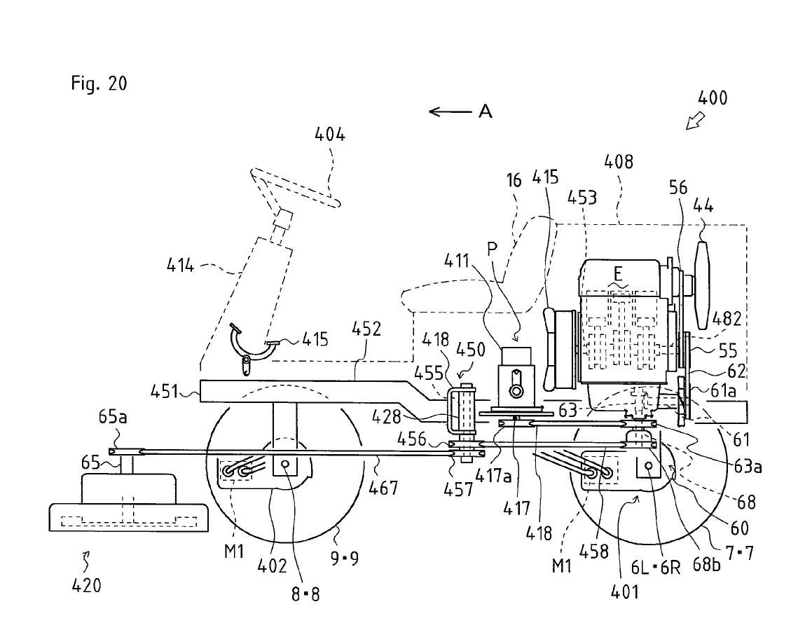

Rear transaxle 1 includes a rear transaxle housing 1H incorporating a hydraulic pump P (see FIGS. 19 and 20 and others), a hydraulic motor M1 driven by hydraulic pump P, left and right rear wheel axles 6, a differential unit (not shown) differentially connecting rear wheel axles 6 to each other, and a deceleration gear train (not shown) drivingly interposed between hydraulic motor M1 and the differential gear unit. Alternatively, hydraulic pump P may be disposed outside of rear transaxle housing 1H if it can be fluidly connected to hydraulic motor M1. Left and right rear wheel axles 6 project leftward and rightward outward from rear transaxle housing 1H so as to be fixedly provided on distal ends thereof with respective rear wheels 7 serving as drive wheels.

Front transaxle 2 includes a front transaxle housing 2H whose lateral center top portion is pivoted onto vehicle frame 3 via a center pivot 5 so as to be vertically swingable at left and right ends thereof. Front transaxle housing 2H incorporates a pair of left and right hydraulic motors M2 and M3. Left and right front wheel support units (not shown) are steerably attached onto left and right ends of front transaxle housing 2H. The front wheel support units support respective axles 8, and left and right front wheels 9 are fixed onto respective axles 8 so as to serve as steerable drive wheels.

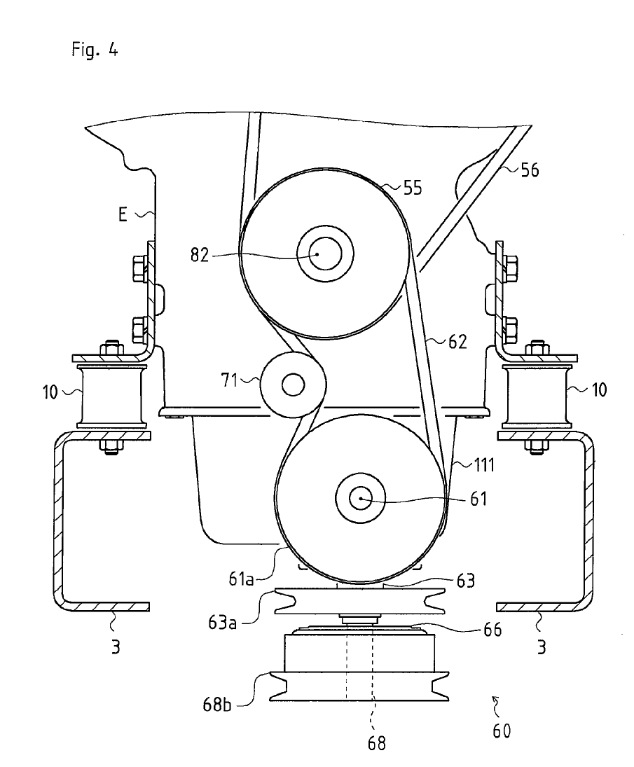

Internal combustion engine E is supported on vehicle frame 3 via plural vibro-isolating rubbers 10 (see FIG. 4), and is enclosed by a bonnet 64. A dashboard is provided immediately behind bonnet 64, and a steering wheel 12 is provided at an upper rear portion of the dashboard. A radiator fan 44 is mounted on vehicle frame 3 immediately in front of internal combustion engine E.

Steering wheel 12 is operably connected at a bottom end thereof to a steering control valve in a valve casing. A power steering cylinder is operably connected to the front wheel support units. The steering control valve is fluidly connected to the power steering cylinder. Therefore, front wheels 9 are steered according to rotation of steering wheel 12 via the front support units.

A speed control pedal 13 is provided at a lower portion of the dashboard, and a brake pedal 41 is disposed in front of speed control pedal 13. Speed control pedal 13 is a seesaw-type pedal, which has front and rear portions movable in opposite directions to each other and has a pivot between the front and rear portions. The front portion of pedal 13 is depressed for setting a forward traveling speed. The rear portion of pedal 13 is depressed for setting a backward traveling speed. A speed control level 14 is pivoted on housing 1H of rear transaxle 1 so as to interlock with a movable swash plate of hydraulic pump P in housing 1H. Further, speed control lever 14 is operably connected to speed control pedal 13 so that the rotation direction and speed of rear wheels 7 (and front wheels 9) are controlled due to the depression direction and degree of speed control pedal 13.

A rear cover 4 is mounted on a rear portion of vehicle frame 3. A driver's seat 16 is mounted on a top portion of rear cover 4. A reservoir tank 28 is disposed just under seat 16 in rear cover 4 so as to store hydraulic fluid for rear transaxle 1. An oiling port, which also serves as a breather, is provided on a top portion of reservoir tank 28.

Mower 20 is a mid-mount mower, as it is called. A usual linkage is arranged below vehicle frame 3 between rear wheels 7 driven by rear transaxle 1 and front wheels 9 driven by front transaxle 2 and, as usual, the linkage suspends mower 20 vertically and movably relative to the ground.

Rotary blades 20a are disposed in mower 20, and a gearbox (not shown) for driving rotary blades 20a is provided on a top portion of mower 20. A vertical mower input shaft 65 projects upward from the gearbox, and is drivingly connected to an output shaft 53 of a later-discussed power transmission mechanism 60.

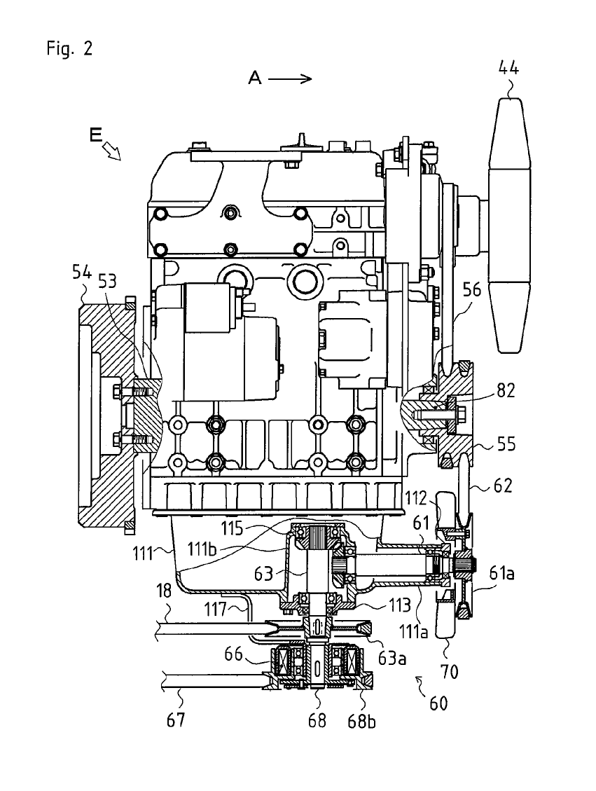

A drive connection mechanism from internal combustion engine E to hydraulic pump P and mower 20 will now be described with reference to FIGS. 1 and 2. Internal combustion engine E is disposed at a lateral center position between the left and right side plates of vehicle frame 3 so as to extend its crankshaft horizontally. A horizontal rear crankshaft end 53 projects rearward from a rear end surface of a crankcase 147 of internal combustion engine E. A flywheel 54 is fixed on a tip of rear crankshaft end 53. A horizontal front crankshaft end 82 projects forward from a front end surface of a gear casing 151 of internal combustion engine E so as to be rotatable in the same direction as the rotational direction of rear crankshaft end 53.

Doubled pulleys 55 are fixed on a tip of front crankshaft end 82. One pulley of doubled pulleys 55 is connected to radiator fan 44 above front crankshaft end 82 via a belt 56. A pulley 61a is fixed on a tip of an input shaft 61 of later-discussed power transmission mechanism 60, and the other pulley of doubled pulleys 55 is drivingly connected to a pulley 61a fixed on a tip of input shaft 61. The power of internal combustion engine E is inputted to input shaft 61, and is transmitted to a vertical output shaft 63 projecting downward from a lower portion of internal combustion engine E, and then is transmitted to a PTO shaft 68 so as to be transmitted to mower 20 and hydraulic pump P constituting a traveling power train.

In other words, output shaft 63 and PTO shaft 68 are connected coaxially to each other, an upper pulley 63a is fixed on a lower portion of output shaft 63, and a lower pulley 68b is fixed on a lower portion of PTO shaft 68. A pulley 17a is fixed on an input shaft 17 of hydraulic pump P, and is drivingly connected to pulley 63a via a belt 18. A pulley 65a is fixed on input shaft 65 projecting from the top portion of mower 20, and is drivingly connected to pulley 68b via a belt 67 and an electromagnetic clutch 66. Electromagnetic clutch 66 is operated for selectively transmitting or cutting off power to and from mower 20. Hydraulic pump P is constantly driven.

Power transmission mechanism 60 provided on internal combustion engine E according to a first embodiment will be detailed with reference to FIGS. 2 to 4. Incidentally, in each of the hereinafter described various embodiments, the power transmission system is defined as a system having an output shaft supported by an oil pan of internal combustion engine E to be disposed perpendicular to the crankshaft (e.g., the output shaft is vertical and perpendicular to the crankshaft when the crankshaft is horizontal).

Power transmission mechanism 60 is disposed in the inside of oil pan 111 disposed at the lower portion of internal combustion engine E. A cylindrical projecting portion 111a projects horizontally outward from a lower portion of a front surface of oil pan 111, and a substantially circular cylindrical projection portion 111b is extended upward into the inside of oil pan 111 from a front portion of a bottom surface of oil pan 111, perpendicular to projecting portion 111b.

A circular opening 111c is formed in a front side surface of projecting portion 111b crossing the center axis of projecting portion 111a. Lids 112 and 113, having respective substantially circular center holes, are provided onto a tip of projecting portion 111a and onto a bottom portion of projecting portion 111b, respectively.

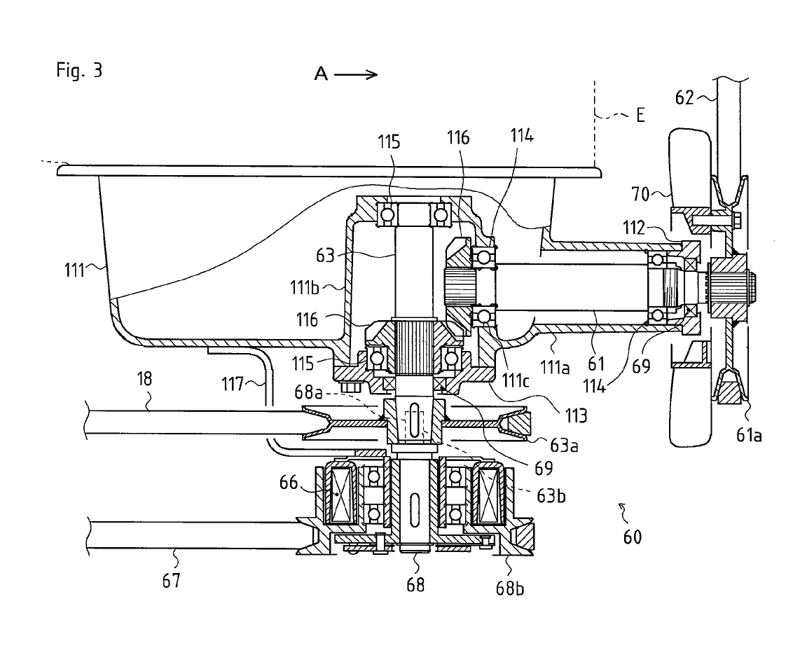

As shown in FIG. 3, a pair of bearings 114 are provided in opening 111c at the front side surface of projecting portion 111b, and in the tip portion of projecting portion 111a, respectively. Input shaft 61 is supported at both end portions thereof by bearings 114, and is extended at one of the ends thereof forward from lid 112.

A pair of bearings 115 are provided in the top portion of projecting portion 111b, and on lid 113, respectively. Output shaft 63 is supported at both end portions thereof by bearings 115, and is extended at one of the ends thereof downward from lid 113.

Lids 112 and 113 are provided on outer end portions thereof with respective oil seals 69 so as to prevent lube filled in oil pan 111 from escaping outward from oil pan 111.

In this way, input shaft 61 and output shaft 63 are directly joined by the wall of oil pan 111 via bearings 114 and 115 provided in projecting portions 111a and 111b so as to economically constitute power transmission mechanism 60 with no additional support members.

Power transmission mechanism 60 includes a gearbox in oil pan 111. Horizontal input shaft 61 and vertical output shaft 63 are inserted into the gearbox so as to be drivingly connected to each other via bevel gears 116. Accordingly, input shaft 61 and output shaft 63 are drivingly connected to each other at the portions thereof disposed in oil pan 111.

In the embodiment of FIGS. 2 and 3, projecting portion 111b of an inside wall of oil pan 111 is formed integrally with oil pan 111 so as to serve as the gearbox. The gearbox and other wall portions of oil pan 111 support input and output shafts 61 and 63, so as to economically constitute the power transmission mechanism with no additional members. Further, the gearbox formed in the oil pan can be supplied with lube that is also used for the oil pan.

Incidentally, bearing 114 disposed in the upper portion of projecting portion 111b and bearing 115 disposed in opening portion 111c can be provided with respective oil seals so as to completely separate the inside of projecting portion 111b from the inside of oil pan 111. Therefore, if the lube filled in projecting portion 111b is grease, for instance, the lube filled in oil pan 111 can be different type oil from the grease. Another effect of the oil-seal is to greatly reduce the agitation resistance of the oil.

A pulley 61a is spline-fitted on a tip portion of input shaft 61 passed through lid 112. A fan 70 is fixed on input shaft 61 behind pulley 61a and coaxially to pulley 61a so as to be rotated together with input shaft 61, thereby cooling oil stored in the oil pan.

Since fan 70 for cooling oil pan 111 is provided on input shaft 61 of power transmission mechanism 60, the oil stored in the oil pan is cooled easily with no additional cooling device.

A pulley 63a is fixed using a key onto a tip portion of output shaft 63 passed through lid 113. A tip portion of output shaft 63 is formed with a tapped hole 63b. PTO shaft 68 for driving a working device serves as a second output shaft on the downstream side of output shaft 63. A top portion of PTO shaft 68 is formed as a threaded portion 68a, and is removably screwed into tapped hole 63b, so that PTO shaft 68 is coaxially fitted into output shaft 63 so as to fix the position of pulley 63a. A pulley 68b is provided on PTO shaft 68 through an electromagnetic clutch 66 serving as a typical clutch. A support member 117, which is crank-shaped when viewed in side, is fixed on a bottom surface of oil pan 111, and supports an electromagnet of electromagnetic clutch 66.

In this way, pulley 68b serving as an output member for a working device is detachable together with electromagnetic clutch 66 from output shaft 63 of power transmission mechanism 60. Therefore, unless a working device is required for actual work, pulley 68b with electromagnetic clutch 66 may be detached from PTO shaft 68. Otherwise, threaded portion 63b may be removed from tapped hole 63b so as to remove PTO shaft 68 together with pulley 68b and electromagnetic clutch 66 from output shaft 63. Consequently, the output member for a working device can be easily removed from the power transmission mechanism so as to easily provide a space below the vehicle frame for various purposes, and to ensure good appearance. On the contrary, if a working device is required, the output member for outputting power to the working device and the clutch can be easily attached to the power transmission mechanism.

Power transmission mechanism 60 is mainly constructed as described above. Pulley 61a is provided on input shaft 61, and pulley 55 is provided on front crankshaft end 82 disposed on a front end surface of internal combustion engine E. A belt 62 is interposed between pulleys 61a and 55. Belt 18 is interposed between pulley 63a on output shaft 63 and pulley 17a on input shaft 17 of hydraulic pump P. Belt 67 is interposed between pulley 68b on PTO shaft 68 and pulley 65a on input shaft 65 disposed on the top of mower 20. Therefore, power from internal combustion engine E is efficiently transmitted to hydraulic pump P for driving axles, and to mower 20 serving as a working device.

In other words, considering a layout in the vehicle, internal combustion engine E is disposed behind front transaxle 2, and below oil pan 111 of internal combustion engine E, i.e., within a plane of projection from internal combustion engine E when viewed in plan. Disposed pulley 63a serves as the output member for hydraulic pump P, and pulley 68b serves as the output member for mower 20, so as to economically extend the two power trains from the single output body (the vertical output shaft) without requiring any additional space for arrangement of the power trains. This arrangement is further adaptable for small-sized vehicles.

Bevel gear 116 fixed on output shaft 63 as shown in FIG. 3 may be alternatively disposed on an upper portion of bearing 115 at the bottom of projecting portion 111b. In this case, the rotary direction of output shaft 63 relative to the rotary direction of input shaft 61 is opposite to that when bevel gear 116 is disposed on the top of output shaft 63 as shown in FIG. 2. Therefore, the rotary direction of output shaft 63 can be easily modified for a working device merely by selecting either the top or bottom of output shaft 63 to fix bevel gear 116 thereon, thereby requiring no large-scale modification in components or control system when exchanging output shaft 63.

When viewed in front as shown in FIG. 4, input shaft 61 of power transmission mechanism 60 is disposed rightward and downward from front crankshaft end 82 provided on internal combustion engine E. An idle pulley 71 is disposed leftward between front crankshaft end 82 and input shaft 61 so as to give an appropriate tension to belt 62 interposed between shafts 61 and 82. The position of input shaft 61 relative to front crankshaft end 82 is determined so as to adequately support output shaft 63 by oil pan 111, so that a horizontal load caused by belt 62 efficiently transmits the power of internal combustion engine E to output shaft 63, or that the horizontal load is prevented from badly influencing the durability of bearings of internal combustion engine E. In the present embodiment, the axis of input shaft 61 is not disposed just below the axis of front crankshaft end 82 but is offset leftward.

Since pulley 68b serving as the output member for a working device is provided thereon with electromagnetic clutch 66, the working vehicle itself does not have to be stopped during temporarily disablement of the working device, thereby making it adaptable to various work matters.

While the first embodiment involves an electromagnetic clutch 66 which serves as the clutch of the power train to a working device, this is not limitative. Alternatively, as shown in a later-discussed third embodiment, the clutch may be a hydraulic clutch using the hydraulic circuit of vehicle 100, or it may be a mechanical tension clutch.

According to the present invention, power transmission mechanism 60 disposed in the inside of oil pan 111 can share common lube filled in oil pan 111 with various components disposed in the inside of internal combustion engine E, thereby requiring no additional oil supply device for lubricating its gears and other parts, and providing advantages in economy and space-saving. Furthermore, if the oil pan 111 were formed in a conventional shape, the arrangement of power transmission mechanism 60 in oil pan 111 would reduce the inside volume of oil pan 111. In the present invention, oil pan 111 is shaped to expand out downward or sideward into otherwise free space so as to compensate for the reduced internal volume.

In this way, in hydraulic drive working vehicle 100, internal combustion engine E having the horizontal crankshaft is supported on vehicle frame 3, hydraulic pump P is disposed in pump housing 1H, hydraulic motor M1 for driving axles is fluidly connected to hydraulic pump P, and mower 20 serves as a working device. Internal combustion engine E is provided with power transmission mechanism 60 for distributing the output power of the crankshaft end (front crankshaft end 82) between hydraulic pump P (the power train for traveling) and mower 20 (the power train for the working device).

Power transmission mechanism 60 includes horizontal input shaft 61, vertical output shaft 63, and projecting portion 111b which is formed on the bottom surface of oil pan 111 into oil pan 111 so as to serve as the gearbox to drivingly connect input and output shafts 61 and 63. In this way, power transmission mechanism 60 is attached to oil pan 111 provided at the lower portion of internal combustion engine E, so as to ensure the same power transmission layout as that of an ordinary internal combustion engine disposed to have a vertically projecting output shaft. This is advantageous in easily constructing power trains for a hydraulic pump and a working device having respective vertical input shafts. Therefore, the present internal combustion engine can be easily made into either a horizontal output type or a vertical output type by any internal combustion engine maker.

Furthermore, in the power transmission mechanism, input shaft 61, output shaft 63 and gearbox 111b for drivingly connecting input and output shafts 61 and 63 are disposed in oil pan 111 provided at the lower portion of internal combustion engine E, so as to efficiently transmit the power from the internal combustion engine to the traveling drive train and the working device drive train while ensuring a sufficient space around the internal combustion engine.

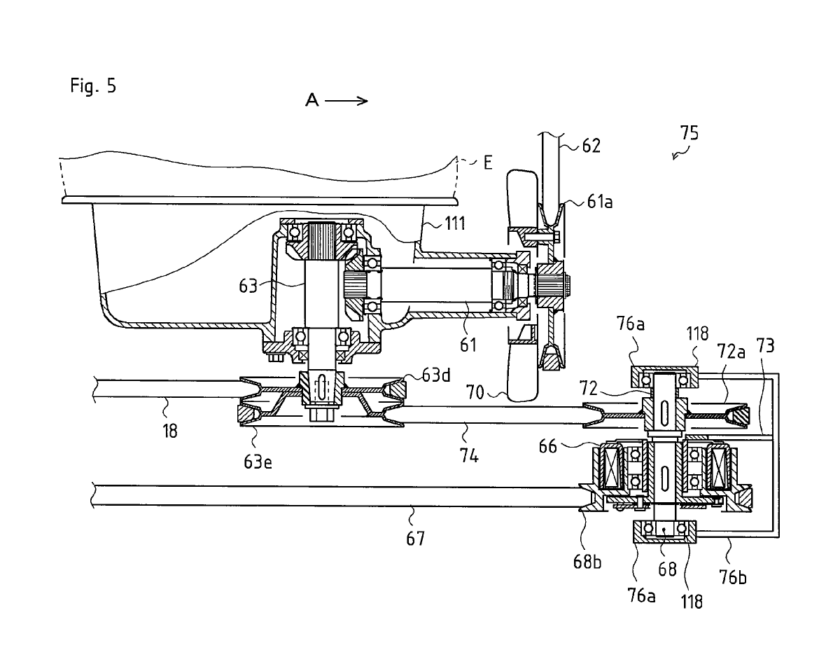

A power transmission mechanism 75 of internal combustion engine E according to a second embodiment will now be described. Components and portions having the same functions as those of power transmission mechanism 60 of the first embodiment are designated by the same reference numerals. In FIG. 5, it is assumed that arrow A is directed forward, and the left and right directions are defined on this assumption.

The inner structure of oil pan 111 disposed at the lower portion of internal combustion engine E, in which horizontal input shaft 61 and vertical output shaft 63 are disposed perpendicular to each other, constitutes the same construction of power transmission mechanism 75 as that of the first embodiment. However, power transmission mechanism 75 has a distinctive construction around the bottom portion of output shaft 63. In this regard, as shown in FIG. 5, PTO shaft 68 and electromagnetic clutch 66 are supported independently of output shaft 63. In this embodiment, electromagnetic clutch 66 is disposed in front of internal combustion engine E. In addition, relatively unrotatable doubled pulleys 63d and 63e are fitted onto the bottom portion of output shaft 63 using a key, so as to serve as a first output member to be drivingly connected to the traveling drive train, and a second output member to be drivingly connected to the working device drive train, respectively.

A pulley 72a is fixed using a key onto the upper portion of PTO shaft 68. A reference numeral 72 designates a retaining ring for preventing the axial movement of pulley 72a.

In this way, at the position forward from internal combustion engine E, or at another appropriate position, PTO shaft 68 is joined in parallel to output shaft 63 by a support frame 76b, fixed to vehicle frame 3, and upper and lower parts 76a, fixed on upper and lower ends of support frame 76b. In this regard, a pair of bearings 118 are disposed in respective support members 76a, so as to rotatably support opposite end portions of vertical PTO shaft 68.

Electromagnetic clutch 66 is fixed at the driving side thereof onto PTO shaft 68, and is provided on the driven side thereof with pulley 68b. A support member 73 is extended from support member 76b so as to support the electromagnet of electromagnetic clutch 66.

With respect to doubled pulleys 63d and 63e provided on the bottom end of output shaft 63, belt 18 is interposed between upper pulley 63d and pulley 17a on input shaft 17 of hydraulic pump P, and belt 74 is interposed between lower pulley 63e and pulley 72a on pulley shaft 72. Further, belt 67 is interposed between lower pulley 68b on PTO shaft 68 and pulley 65a on input shaft 65 on the top of mower 20.

The basic construction of power transmission mechanism 75 is similar to that described above. Belt 62 is interposed between pulley 61a on input shaft 61 and pulley 55 on front crankshaft end 82 disposed on the front end surface of internal combustion engine E. The power of internal combustion engine E is first transmitted to power transmission mechanism 75 via belt 62. Then it is transmitted to hydraulic pump P (the traveling drive train) via belt 18, and simultaneously to electromagnetic clutch 66 via belt 74, and then to mower 20 (the working device drive train) via belt 67. Therefore, the power transmission to the working device can be easily selectively switched on or off by operating electromagnetic clutch 66.

Furthermore, in the present embodiment, due to the arrangement of electromagnetic clutch 66 independent of input and output shafts 61 and 63, if the working device such as mower 20 is not equipped to the body of vehicle 100, for instance, the surrounding components (such as PTO shaft 68, pulley 72a and belts 67 and 74) can be easily removed so as to expand the usable lower space of vehicle 100.

In this way, PTO shaft 68 provided thereon with electromagnetic clutch 66 is disposed independently of output shaft 63, so as to ensure a sufficient space below the oil pan, and to ensure a sufficient space for work around its portion for transmitting power to the working device drive train, thereby facilitating its maintenance and attachment or detachment of the working to and from the vehicle body.

In addition, lower pulley 68b on PTO shaft 68 is further lowered in light of the location of low pulley 65a on mower 20 so that belt 67 is disposed parallel so as to enhance its power transmission efficiency for mower 20 during work. In this regard, a tension clutch is provided to belt 74 instead of electromagnetic clutch 66, because belt 74 is not vertically movable during vertical motion of mower 20 in comparison with belt 67.

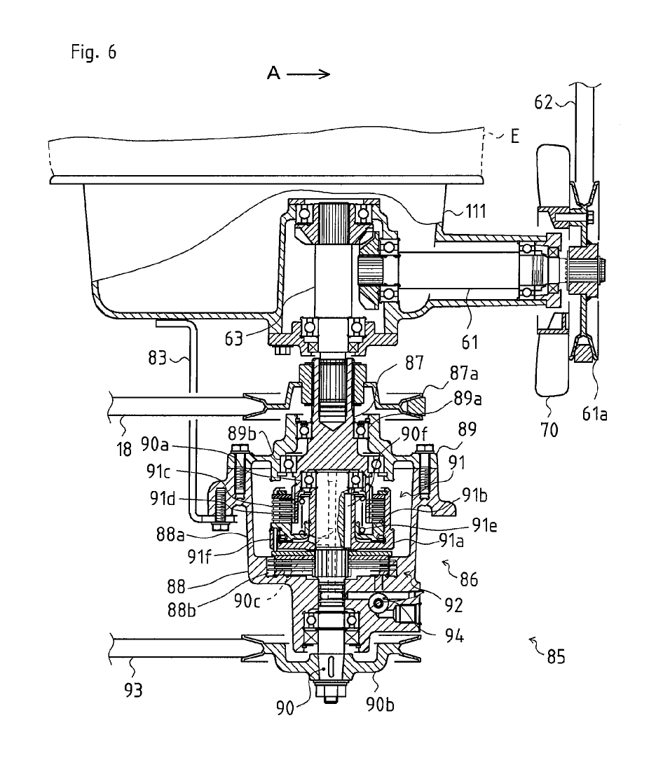

A power transmission mechanism 85 of internal combustion engine E according to a third embodiment will be described. Components and portions having the same functions as those of power transmission mechanisms of the first and second embodiments are designated by the same reference numerals. In FIG. 6, it is assumed that arrow A is directed forward, and the left and right directions are defined on this assumption.

Power transmission mechanism 85 includes the same construction as those of the first and second embodiments, i.e., the drive connection of horizontal input shaft 61 and vertical output shaft 63 in oil pan 11 disposed at the lower portion of internal combustion engine E. The point of distinction of the present embodiment is to use a hydraulic clutch unit 86 for transmitting power to the working device. In this regard, as shown in FIG. 6, hydraulic clutch unit 86 is disposed vertically downward from output shaft 63, and a clutch input shaft 87 projects upward from a top portion of hydraulic clutch unit 86 to be fixed to the bottom portion of output shaft 63.

Hydraulic clutch unit 86 will now be described. A clutch casing 88 is formed as a main body of hydraulic clutch unit 86, and is detachably and fixedly provided on the top portion thereof with a lid 89 by a bolt or the like. Vertical clutch input shaft 87 is joined to a central upper portion of lid 89. Clutch input shaft 87 joined to housing 89 includes an upwardly projecting upper portion formed with an upwardly opened vertical shaft hole 87b, into which the bottom portion of output shaft 63 is spline-fitted. A pulley 87a is spline-fitted on the outer peripheral surface of the upper end portion of clutch input shaft 87. A support member 83, which is crank-shaped when viewed in side, is fixed to the bottom surface of oil pan 111, and clutch casing 88 is joined to support member 83 detachably by a bolt or the like or non-detachably by welding or the like.

Clutch casing 88 is formed therein with a working device clutch housing portion 88a which is extended downward to house the lower portion of clutch input shaft 87. A vertical PTO shaft 90 is joined to a bottom surface of working device clutch housing portion 88a, and is rotatably fitted at a top portion thereof into the bottom portion of clutch input shaft 87. A main working device hydraulic clutch body 91 is disposed in clutch casing 88 and is interposed between clutch input shaft 87 and PTO shaft 90. A brake support part 88b is formed on the inner bottom surface of working device clutch housing portion 88a. A brake 92 preventing inertial rotation of PTO shaft 90 is attached to brake support part 88b so as to be interlocked with main clutch body 91.

PTO shaft 90 projects downward from the bottom of clutch casing 88 so as to be fixedly provided thereon with a pulley 90b over which a belt 93 is looped for driving connection to the working device (mower 20).

In main clutch body 91, a boss portion of a clutch drum 91a is relatively non-rotatably fitted on PTO shaft 90 using a key 90f. Bearings 89a and 89b having different sizes are provided at upper and lower end portions of lid 89 so that clutch input shaft 87 is joined to the outer peripheral surface thereof by bearings 89a and 89b. The top portion of PTO shaft 90 is fitted into clutch input shaft 87 through a bearing 90a provided in the bottom portion of clutch input shaft 87. Therefore, PTO shaft 90 is relatively rotatably supported by clutch casing 88 concentrically with clutch input shaft 87.

The lower portion of clutch input shaft 87 is extended downward so as to form a spline boss to be fitted into a clutch drum 91a. In clutch drum 91a, plural friction discs 91c are relatively non-rotatably and axially slidably fitted to clutch drum 91a, plural friction discs 91d are relatively non-rotatably and axially slidably fitted to the spline boss of clutch input shaft 87, and friction discs 91c and 91d are alternately aligned. A piston 91b is disposed below friction discs 91c and 91d so that friction discs 91c and 91d are pressed against one another by upward sliding of piston 91b so as to engage main clutch body 91, and are separated from one another by downward sliding of piston 91b so as to disengage main clutch body 91.

Piston 91b is biased downward, toward the side opposite to friction discs 91c and 91d (namely, in the direction for disengaging main clutch body 91). A hydraulic fluid chamber is formed in clutch drum 91a below piston 91b. When fluid is supplied to the hydraulic fluid chamber through a fluid path 90c bored in PTO shaft 90, piston 91b is pushed upward and is engaged with main clutch body 91 so that clutch drum 91a is rotated integrally with PTO shaft 90, which is connected drivingly to clutch input shaft 87. On the other hand, when fluid is released from the hydraulic fluid chamber, piston 91b slides downward so as to be separated from main clutch body 91, whereby clutch input shaft 87 is cut off from the rotary power of PTO shaft 90. At this time, piston 91b transmits a biasing force of a spring 91e through a brake interlock pin 91e to a brake plate of a brake 92, whereby the brake is actuated.

A fluid path from an external hydraulic pressure source to fluid path 90c in PTO shaft 90 is bored in a lower front portion of a clutch casing 143, and an electromagnetic switch valve 94 is interposed at the middle of the fluid path. By setting electromagnetic switch valve 94 to the open position, external fluid is supplied through fluid path 90c to the hydraulic fluid chamber of main clutch body 91, whereby main clutch body 91 is engaged. On the other hand, by setting electromagnetic switch valve 94 to the closed position, fluid from the hydraulic fluid chamber of main clutch body 91 is drained, whereby main clutch body 91 is disengaged. Possible external hydraulic pressure sources may include but are not limited to a hydraulic pump (not shown) attached to an internal-combustion engine, or a charge pump (not shown) connected to hydraulic pump P of the traveling drive train.

When hydraulic clutch unit 86 is constructed as described above, the power transmission to the working device is easily switched on or off by operating main clutch body 91. When the working device such as mower 20 is not equipped on the main body of vehicle 100, hydraulic clutch unit 86 can be removed from support member 83 so as to expand the usable lower space of vehicle 100.

In this regard, belt 62 is interposed between pulley 61a on input shaft 61 and pulley 55 on front crankshaft end 82, which are both disposed on the front end surface of internal combustion engine E. Belt 18 is interposed between pulley 87a on clutch input shaft 87 of hydraulic clutch unit 86 and pulley 17a on input shaft 17 of hydraulic pump P. Belt 93 is interposed between pulley 90b on PTO shaft 90 of hydraulic clutch unit 86 and pulley 65a on input shaft 65 on the top of mower 20. Accordingly, the power of internal combustion engine E is efficiently transmitted to hydraulic pump P (traveling drive train) and mower 20 (working device drive train).

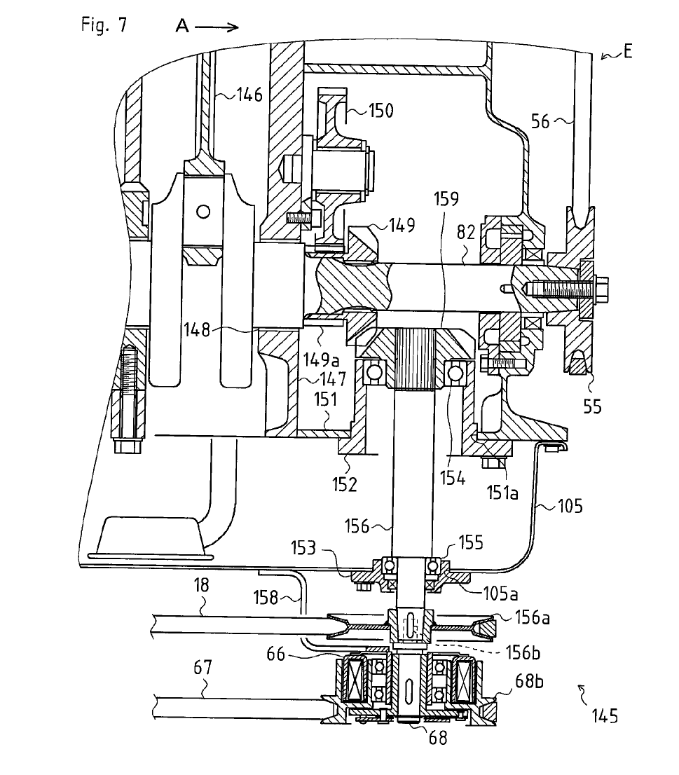

A power transmission mechanism 145 of internal combustion engine E according to the fourth embodiment will now be described with reference to FIG. 7. Components and portions having the same functions as those of power transmission mechanisms of the first through third embodiments are designated by the same reference numerals. In FIG. 7, it is assumed that arrow A is directed forward, and the left and right directions are defined on this assumption.

Power transmission mechanism 145 differs from the power transmission mechanism of the first embodiment to the extent that no input shaft parallel to crankshaft 82 is provided, so the driving force is extracted directly from crankshaft 82 in internal combustion engine E.

In this regard, inside internal combustion engine E, front crankshaft end 82 is pivoted on a front wall of a crank casing 147 through a bushing 148. Reference numeral 146 designates a connecting rod 146 connected to the crankshaft.

Front crankshaft end 82 projects through the front wall of crank casing 147 and is positioned in gear casing 151 attached to the front surface of crank casing 147. In the vicinity of the front surface of crank casing 147, a bevel gear 149 is relatively non-rotatably fitted on the spline-toothed portion of crankshaft (the basal portion of front crankshaft end 82). A gear 149a is formed on the boss part of bevel gear 149 and engages with an idle gear 150 pivoted on crank casing 147 above front crankshaft end 82. Outside of the scope of FIG. 7, idle gear 150 engages and interlocks with a gear on a camshaft or governor transmission shaft so as to rotate the camshaft or governor transmission shaft with the rotation of crankshaft 82.

A hole 151a is provided in the bottom surface of gear casing 151, and a cylindrical bearing member 152 is projected upward through hole 151a so as to be disposed detachably. A hole 105a is provided just below bearing member 152, in a bottom surface of an oil pan 105 provided in the lower portion of internal combustion engine E, and a lid 153 is disposed detachably by using hole 105a.

A bearing 154 is provided on an upper end portion of bearing member 152 and a bearing 155 is provided on an upper end portion of lid 153 so that an output shaft 156 perpendicular to crankshaft 82 is pivoted by bearings 154 and 155. An oil seal 157 is provided around output shaft 156 extending from lid 153 so as to prevent lubricating oil in oil pan 105 from leaking outside.

The lower end portion of output shaft 156 is first pivoted by bearing 155 provided on the upper end portion of lid 153, and then penetrates lid 113 and projects downward. A pulley 156a is relatively non-rotatably fixed on the lower end portion of output shaft 156. A tapped hole 156b is formed in the lower end portion of output shaft 156. Threaded portion 68a provided at the top of PTO shaft 68 as a second output shaft on the downstream side of output shaft 156 is detachably screwed into tapped hole 156b so that PTO shaft 68 is coaxially inserted into output shaft 156. Pulley 68b is provided on PTO shaft 68 through an electromagnetic clutch 66, and the main electromagnet body of electromagnetic clutch 66 is supported by a support member 158 which is fixed to the lower surface of oil pan 105 and crank-shaped when viewed in side.

A bevel gear 159 is spline-fitted on the tip portion of output shaft 156 projecting from the upper end of bearing member 152, and it engages with bevel gear 149 fixed to front crankshaft end 82.

Power transmission mechanism 145 is constructed as described above. Similarly to power transmission mechanism 60 of internal combustion engine E of the first embodiment, belt 18 is interposed between pulley 156a on clutch input shaft 156 of hydraulic clutch unit 86 and pulley 17a on input shaft 17 of hydraulic pump P. Belt 67 is interposed between pulley 68b on PTO shaft 68 and pulley 65a on input shaft 65 on the top of mower 20. Accordingly, the power of internal combustion engine E is efficiently transmitted to hydraulic pump P (traveling drive train) and mower 20 (working device drive train).

With regard to the present embodiment, driving force is inputted to power transmission mechanism 145 inside internal combustion engine E so that the internal combustion engine is constructed compactly, without additionally providing an input shaft or the like forward from oil pan 105.

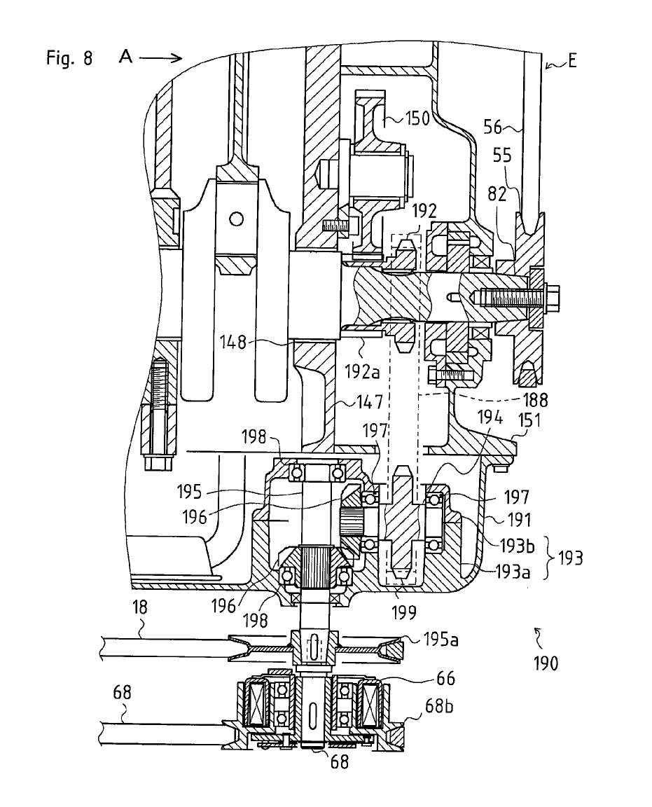

A power transmission mechanism 190 of internal combustion engine E according to the fifth embodiment will now be described with reference to FIG. 8. Components and portions having the same functions as those of power transmission mechanisms of the first through fourth embodiments are designated by the same reference numerals. In FIG. 8, it is assumed that arrow A is directed forward, and the left and right directions are defined on this assumption.

Power transmission mechanism 190 is similar in construction to power transmission mechanism 145 of the fourth embodiment in that driving force in both is directly taken out from front crankshaft end 82 inside internal combustion engine E. However, power transmission mechanism 190 has a distinctive construction in its drive transmission structure from front crankshaft end 82.

In this regard, similarly to the fourth embodiment, in the vicinity of the front surface of crank casing 147 in gear casing 151, a sprocket 192 is relatively non-rotatably fixed on the part of basal portion of front crankshaft end 82 in which the spline teeth are formed. A gear 192a is formed on the boss part of sprocket 192 so as to drive the camshaft or governor transmission shaft (not shown).

A gear casing 193, comprising a lower gear casing 193a formed integrally with an oil pan 191 and an upper gear casing 193b attached to lower gear casing 193a, is disposed on the front portion of the inner bottom surface of oil pan 191. An input shaft 194 and an output shaft 195, which are perpendicular to each other through bevel gears 196, are provided in gear casing 193.

In this regard, gear casing 193 supports both ends of fore-and-aft input shaft 194 through bearings 197 at the inside front portion, and supports vertical output shaft 195 through bearings 198 at the inside portion behind input shaft 194. Bevel gear 196 fixed on the rear end portion of input shaft 194 engages with bevel gear 196 fixed on the substantial center portion of output shaft 195.

On the other hand, a sprocket 199 is relatively non-rotatably fixed on the center portion of input shaft 194, and is drivingly connected through a silent chain 188 to sprocket 192 provided on front crankshaft end 82.

Similarly to the fourth embodiment, the lower end of output shaft 195 is projected from the lower surface of oil pan 191, is fixedly provided thereon with a pulley 195a, and is connected to PTO shaft 68. Electromagnetic clutch 66 and pulley 68b are fixed on PTO shaft 68.

Power transmission mechanism 190 is constructed as described above. Similarly to the fourth embodiment, belt 18 is interposed between pulley 195a on output shaft 195 and pulley 17a on input shaft 17 of hydraulic pump P. Belt 67 is interposed between pulley 68b on PTO shaft 68 and pulley 65a on input shaft 65 disposed on the top of mower 20. Accordingly, the power of internal combustion engine E is efficiently transmitted to hydraulic pump P (traveling drive train) and mower 20 (working device drive train).

With regard to the present embodiment, as compared to the fourth embodiment, the driving force is inputted to power transmission mechanism 145 through silent chain 188 inside internal combustion engine E so that the internal combustion engine is constructed more compactly by shortening the fore-and-aft width of gear casing 151.

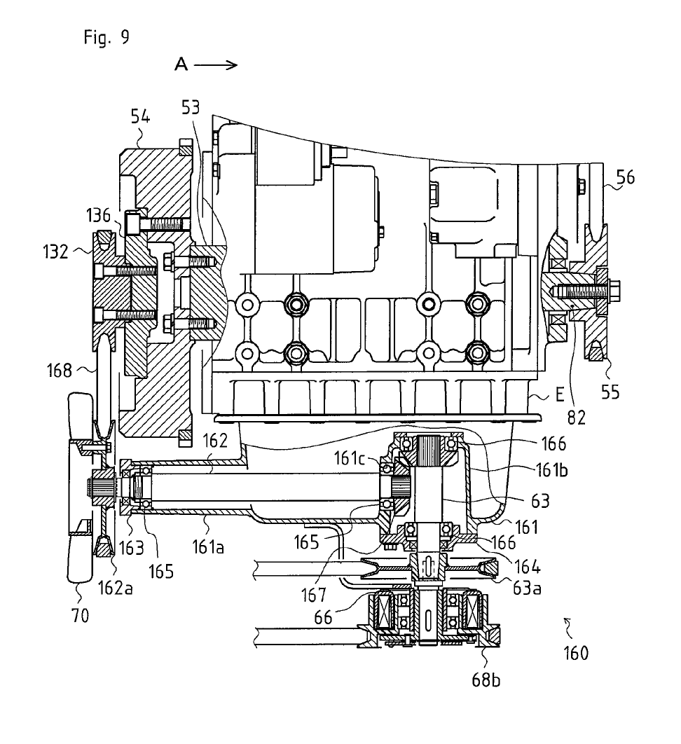

A power transmission mechanism 160 of internal combustion engine E according to the sixth embodiment will now be described with reference to FIG. 9. Components and portions having the same functions as those of power transmission mechanisms of the first through fifth embodiments are designated by the same reference numerals. In FIG. 9, it is assumed that arrow A is directed forward, and the left and right directions are defined on this assumption.

Power transmission mechanism 160 of internal combustion engine E according to the sixth embodiment is similar to that of the first embodiment in that an input shaft 162 and output shaft 63, which are perpendicular to each other, are provided in an oil pan 161. However, power transmission mechanism 160 has a distinctive construction in that input shaft 162 is extended rearward from internal combustion engine E so that the power of internal combustion engine E is extracted from the flywheel 54 side and transmitted to input shaft 162.

In this regard, as shown in FIG. 9, a cylindrical outward projection portion 161a is provided horizontally in the lower portion of the rear surface of oil pan 161. The rear end of input shaft 162 is pivoted by a bearing 165 disposed on the rear end of projection portion 161a, and then penetrates a lid 163 and projects rearward. A pulley 162a is spline-fitted on the rearward projecting tip portion of input shaft 162. On the other hand, the front end of input shaft 162 is pivoted by bearing 165 disposed in an opening 161c of a projection portion 161b and then projected forward to some degree. A bevel gear 167 is spline-fitted on the forward projecting tip portion of input shaft 162. Similarly to the first embodiment, output shaft 63 engages with input shaft 162 through a bevel gear. The lower end of output shaft 63 is provided thereon with pulley 63a and electromagnetic clutch unit 86, and is connected through the belt to hydraulic pump P (traveling drive train) and mower 20 (working device drive train).

On the tip portion of pulley 162a, fan 70 is fixed coaxially to pulley 162a. Fan 70 is rotated by the rotation of input shaft 162 so as to cool oil pan 161.

On the other hand, flywheel 54 is fixed on rear crankshaft end 53 projecting from the rear end of internal combustion engine E, and a pulley 132 is relatively non-rotatably attached through a connection board 136 to the center of flywheel 54 coaxially. A belt 168 is provided between pulley 162a fixed on the tip portion of input shaft 162 and pulley 132 so as to transmit the driving force of internal combustion engine E to power transmission mechanism 160.

With regard to power transmission mechanism 160 constructed as described above, a space is provided in front of oil pan 161 so that the free space adjacent to front transaxle 2 is available to activities such as maintenance or repair.

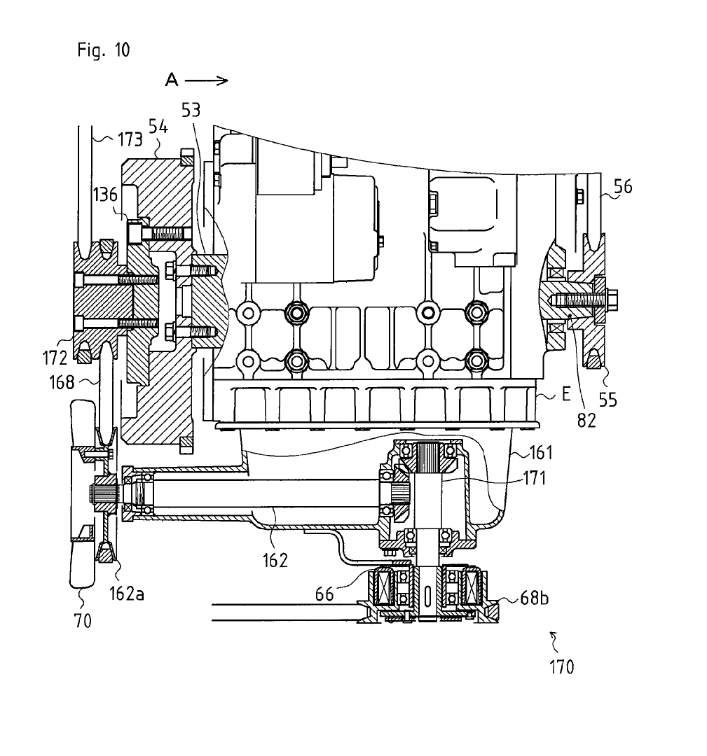

A power transmission mechanism 170 of internal combustion engine E according to the seventh embodiment will now be described with reference to FIG. 10. Components and portions having the same functions as those of power transmission mechanisms of the first through sixth embodiments are designated by the same reference numerals. In FIG. 10, it is assumed that arrow A is directed forward, and the left and right directions are defined on this assumption.

Compared to the sixth embodiment, power transmission mechanism 170 has a distinctive construction in that power transmission mechanism 170 is drivingly connected to hydraulic pump P (traveling drive train) by a pulley 172 fixed on flywheel 54.

In this regard, doubled pulleys 172 are relatively non-rotatably fixed through connection board 136 coaxially to the center of flywheel 54 at the rear end side of internal combustion engine E.

One side pulley of doubled pulleys 172 is drivingly connected through belt 168 to pulley 162a fixed on input shaft 162, and the other side pulley of doubled pulleys 172 is drivingly connected through a belt 173 to a pulley fixed on an input shaft of the hydraulic pump (not shown). In this case, hydraulic pump P is separated from rear transaxle housing 1H and fluidly connected through a piping to hydraulic motor M1 in rear transaxle housing 1H.

With regard to power transmission mechanism 170 constructed as described above, similarly to the sixth embodiment, a space is provided in front of oil pan 161 so that the free space adjacent to front transaxle 2 is available for activities such as maintenance or repair. Since the flywheel of internal combustion engine E constitutes the transmission train to hydraulic pump P (traveling drive train), an output shaft 171 of the power transmission mechanism 170 is provided on a lower portion thereof with no pulley for transmitting power to hydraulic pump P and with only pulley 68b through electromagnetic clutch 66 to mower 20 (working device drive train), whereby a space is secured in the lower portion of the vehicle frame.

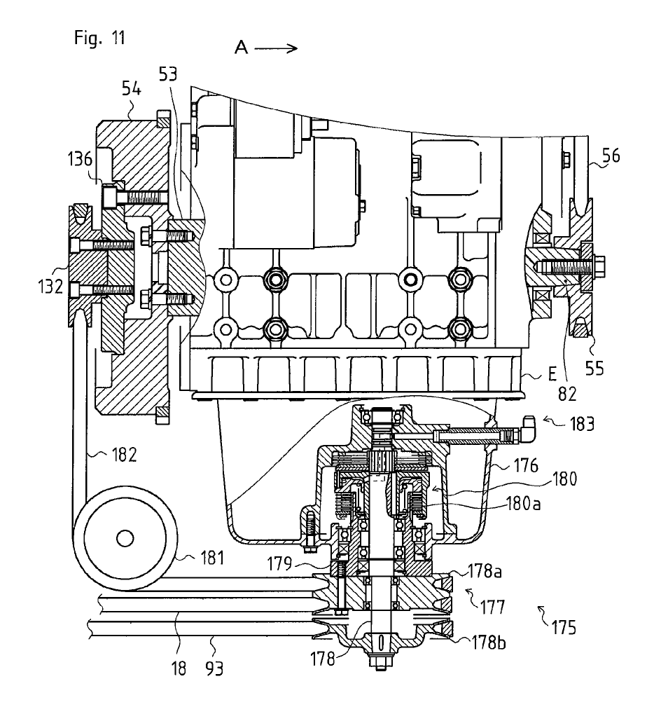

A power transmission mechanism 175 of internal combustion engine E according to the eighth embodiment will now be described with reference to FIG. 11. Components and portions having the same functions as those of power transmission mechanisms of the first through seventh embodiments are designated by the same reference numerals. In FIG. 11, it is assumed that arrow A is directed forward, and the left and right directions are defined on this assumption.

Similar to power transmission mechanism 85 of the third embodiment, power transmission mechanism 175 is disposed inside an oil pan 176 disposed in the lower portion of internal combustion engine E, and is provided with a hydraulic clutch unit 177 for switching on and off the power transmission to mower 20 (working device drive train). Power transmission mechanism 175 has a distinct construction in that the power of internal combustion engine E is taken of from the flywheel 54 side. In this regard, as shown in FIG. 11, hydraulic clutch unit 177 having substantially the same construction as that of the third embodiment is arranged inside oil pan 176, and a supply port 183 for supplying hydraulic fluid from the above-mentioned external hydraulic pressure source to unit 177 is opened in the peripheral wall of oil pan 176. A PTO shaft 178 is projected downward from hydraulic clutch unit 177.

Upper doubled pulleys 178a and a lower pulley 178b are relatively non-rotatably provided on the lower end portion of PTO shaft 178. Furthermore, doubled pulleys 178a are detachably fixed onto a clutch input shaft 179 arranged on the outer peripheral surface of PTO shaft 178. Though clutch input shaft 179 is rotatable relative to PTO shaft 178, clutch input shaft 179 is connected to PTO shaft 178 by engagement of a working device clutch 180.

On the other hand, a counter pulley 181, whose rotary axis is perpendicular to that of pulley 132 relatively non-rotatably attached to flywheel 54 at the rear end side of internal combustion engine E, is pivoted by vehicle frame 3. Pulley 132 is drivingly connected through counter pulley 181 to the upper side pulley of doubled pulleys 178a by a twisted belt 182.

The lower side pulley of doubled pulleys 178a is connected through belt 18 to hydraulic pump P (traveling drive train). Pulley 178b fixed on the lower end of PTO shaft 178 is connected through belt 93 to mower 20 (working device drive train).

Since counter pulley 181 and twisted belt 182 change the angle of input direction of power transmission mechanism 175 as described above, the power transmission mechanism is simplified and economized.

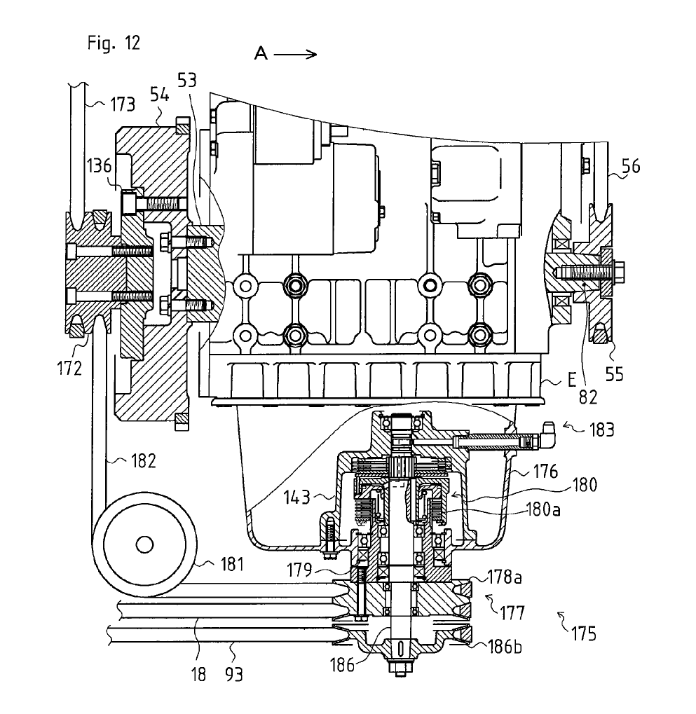

A power transmission mechanism 185 of internal combustion engine E according to the ninth embodiment will now be described with reference to FIG. 12. Components and portions having the same functions as those of power transmission mechanisms of the first through eighth embodiments are designated by the same reference numerals. In FIG. 12, it is assumed that arrow A is directed forward, and the left and right directions are defined on this assumption.

Power transmission mechanism 175 is the same as that of the eighth embodiment. The ninth embodiment has a distinctive construction in that double pulleys 172 are disposed so as to receive a plurality of powers from the flywheel 54 side.

In this regard, one side pulley of doubled pulleys 172 fixed to the center of flywheel 54 at the rear end side of internal combustion engine E is used for the input of power transmission mechanism 175 through twisted belt 182. The other side pulley of doubled pulleys 172 can be used for driving through belt 173, e.g., for driving another hydraulic pump for supplying hydraulic pressure to a power steering mechanism if the power steering mechanism is provided as a steering system of front wheels 9. Otherwise, when a hydraulic pump is separated from the rear transaxle, an input pulley of the hydraulic pump can be driven by belt 173. In this case, the lower side pulley of doubled pulleys 172 is removed.

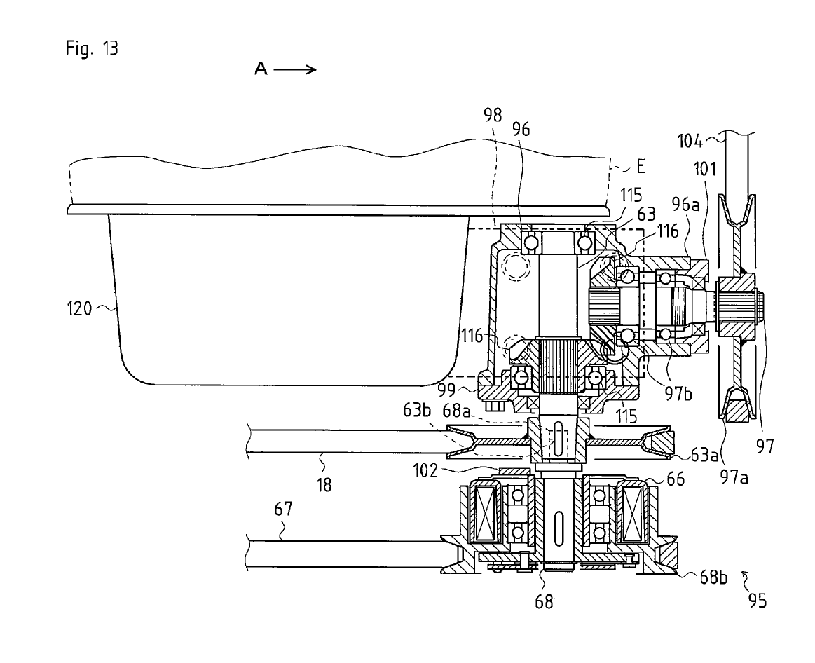

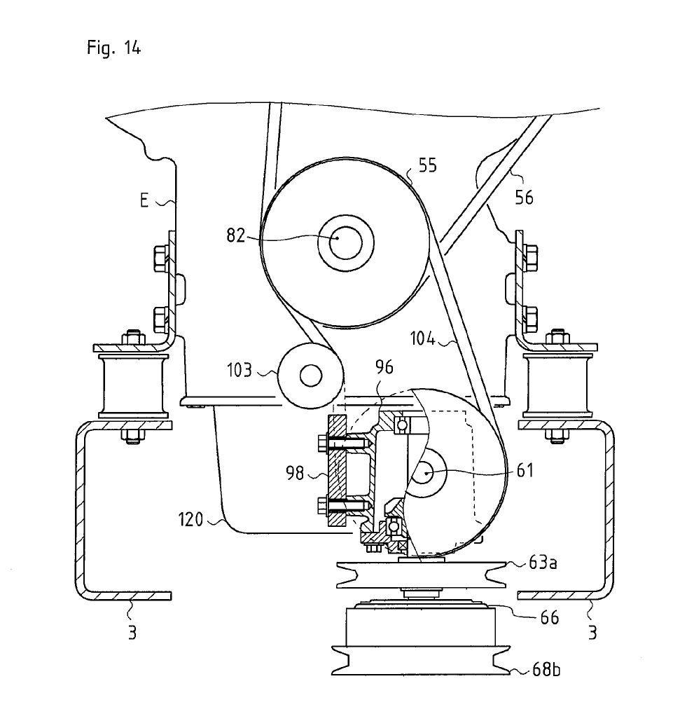

A power transmission mechanism 95 of internal combustion engine E according to the tenth embodiment will now be described with reference to FIGS. 13 and 14. Components and portions having the same functions as those of power transmission mechanisms of the first through ninth embodiments are designated by the same reference numerals. In FIGS. 13 and 14, it is assumed that arrow A is directed forward, and the left and right directions are defined on this assumption.

Power transmission mechanism 95 is constructed in the same general manner, such as the arrangement of the input and output shafts, and the application of the electromagnetic clutch, as that of the first embodiment. However, the present embodiment has a distinctive construction in that power transmission mechanism 95 is adjacent to an oil pan 120 of internal combustion engine E. In this regard, as shown in FIGS. 13 and 14, a recess is formed in the front surface of oil pan 120, and a support member 98 projects into the recess. Power transmission mechanism 95 is detachably fixed on a side surface of support member 98.

A cylindrical projecting portion 96a is provided on a center of a front surface of a gearbox 96 serving as the main body of power transmission mechanism 95. A lid 99 is detachably fixed through bolts or the like to the lower end portion of gearbox 96, and a lid 101 to the front end portion of projecting portion 96a. A circular opening is provided at the center of each of lids 99 and 101. A pair of bearings 96b are provided on lid 99 and the upper portion of gearbox 96, respectively, so as to pivot output shaft 63 and PTO shaft 68 attached coaxially to output shaft 63, respectively.

Projection portion 96a is provided on the basal portion thereof and the substantially center portion thereof with respective bearings 97b pivoting an input shaft 97 extending forward and perpendicular to PTO shaft 68.

The front end portion of input shaft 97 is pivoted by bearing 97b disposed on the front end of projection portion 96a, and then penetrates lid 101 and projects further forward. A pulley 97a is spline-fitted on the tip of front end portion of input shaft 97. The rear end portion of input shaft 97 is pivoted by bearing 97b disposed on the basal portion of projecting portion 96a, and then projects rearward to some degree. Bevel gear 116 is spline-fitted on the tip of rear end portion of input shaft 97.

On the other hand, the lower end portion of output shaft 63 is pivoted by bearing 115 disposed in gearbox 96, and then penetrates lid 99 and projects further downward. Pulley 63a is fixed using a key to the tip of lower end of output shaft 63. Tapped hole 63b is formed in the lower tip portion of output shaft 63. Threaded portion 68a, which is formed on the upper end portion of PTO shaft 68 receiving the power from output shaft 63, is detachably screwed into tapped hole 63b, so that PTO shaft 68 is inserted coaxially to output shaft 63. Pulley 68b is provided on PTO shaft 68 through electromagnetic clutch 66, and the main electromagnet body of electromagnetic clutch 66 is supported by a support member 102 fixed on the rear surface of vehicle frame 3.

As shown in FIG. 13, bevel gear 116 is spline-fitted on output shaft 63 below bearing 115 disposed on the lower end of gearbox 96 and engages with bevel gear 116 fixed to the rear end of input shaft 61.

Power transmission mechanism 95 is mainly constructed as described above. As mentioned above, a belt 104 is interposed between pulley 97a provided on input shaft 97 and pulley 55 provided on front crankshaft end 82, which are both disposed on the front end surface of internal combustion engine E. Belt 18 is interposed between pulley 63a on output shaft 63 and pulley 17a on input shaft 17 of hydraulic pump P. Belt 67 is interposed between pulley 68b on PTO shaft 68 and pulley 65a on input shaft 65 on the top of mower 20. Accordingly, the power of internal combustion engine E is efficiently transmitted to hydraulic pump P (traveling drive train) and mower 20 (working device drive train).

With regard to the present embodiment (the tenth embodiment), bevel gear 116 fixed on output shaft 63 may be reversed and disposed below bearing 115 provided on the upper end portion of gearbox 96. In this case, the rotary direction of output shaft 63 may be reversed to the rotary direction of input shaft 97.

As shown in FIG. 14, an idle pulley 103 is pivoted between front crankshaft end 82 of internal combustion engine E and input shaft 61 leftward when viewed in plan so as to apply an appropriate tension onto belt 104 interposed between shafts 61 and 82.

The power transmission to the working device drive train is easily switched on or off by operating electromagnetic clutch 66. When the working device such as mower 20 is not provided on the main body of vehicle 100, PTO shaft 68 can be removed from output shaft 63 so as to ensure available free space below vehicle 100. The inside of gearbox 96 is completely separated from the inside of oil pan 111 so that a different kind of oil from lubricating oil, such as grease, with which oil pan 111 is filled, may be used as lubricating oil of gearbox 96. Furthermore, stirring resistance of the oil is reduced.

Similarly to the first embodiment, with regard to the present embodiment (the tenth embodiment), the mechanism for transmitting power to the working device drive train is provided with electromagnetic clutch 66. However, other configurations are possible. For example, as shown in the third embodiment, a hydraulic clutch using a hydraulic pressure source, with which vehicle 100 is equipped, or an easy mechanical tension clutch may be alternatively used.

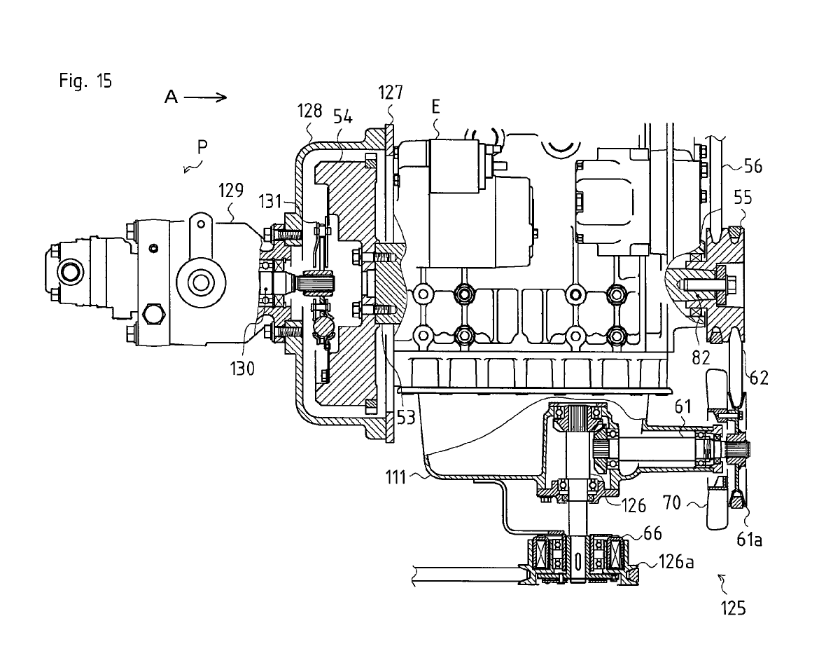

A power transmission mechanism 125 of internal combustion engine E according to the eleventh embodiment and power transmission mechanism 140 of internal combustion engine E according to the twelfth embodiment will now be described respectively with reference to FIGS. 15 through 17. As shown in later-discussed vehicles 300 and 400, these embodiments can be adapted in the case that hydraulic pump P of the transaxle is disposed separately outside rear transaxle housing 1H.

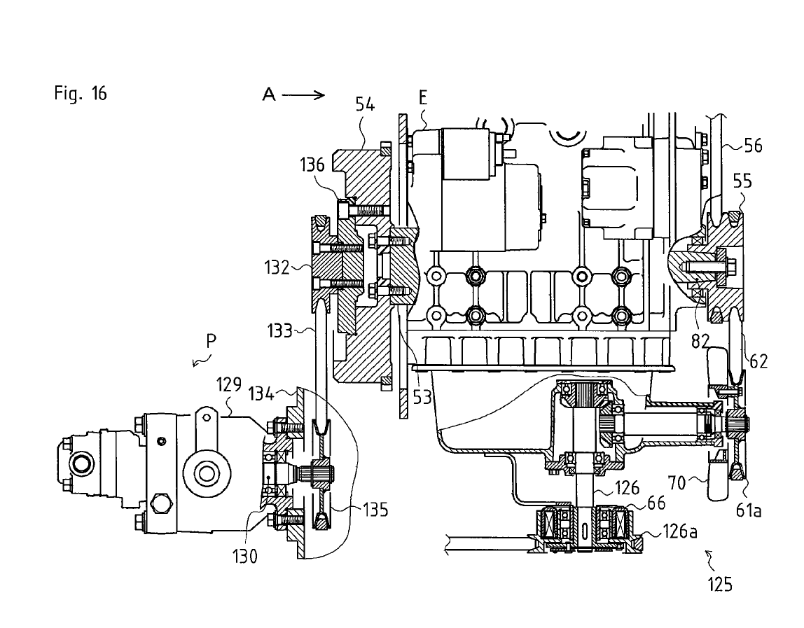

Power transmission mechanism 125 and internal combustion engine E according to the eleventh embodiment comprising it will now be described with reference to FIGS. 15 and 16. Components and portions having the same functions as those of power transmission mechanisms of the first through tenth embodiments are designated by the same reference numerals. In FIGS. 15 and 16, it is assumed that arrow A is directed forward, and the left and right directions are defined on this assumption.

Power transmission mechanism 125 is similar to that of the first embodiment in that input shaft 61 and output shaft 126 are provided perpendicularly to each other in oil pan 111 disposed in the lower portion of internal combustion engine E. However, power transmission mechanism 125 has a distinctive construction in that the drive of hydraulic pump P is taken out not through output shaft 126 but through rear crankshaft end 53 behind internal combustion engine E.

With regard to internal combustion engine E according to the eleventh embodiment comprising power transmission mechanism 125, as shown in FIG. 15, a bell housing 128 as a support member is fixed to a mounting flange 127 provided on the rear surface of internal combustion engine E. A pump housing 129 incorporating hydraulic pump P is supported through bell housing 128 so as to have a pump shaft 130 projecting forward. On the other hand, flywheel 54, which is surrounded by the bell housing, is provided on the tip portion of rear crankshaft end 53 of internal combustion engine E. Pump shaft 130 of hydraulic pump P is connected coaxially to rear crankshaft end 53 through a coupling (damper) 131 fixed on the rotary center of flywheel 54. In the case that pump shaft 130 of hydraulic pump P is disposed separately rearward from internal combustion engine E and parallel to the crankshaft in vehicle frame 3, the bell housing is removed and coupling (damper) 131 is connected to pump shaft 130 through a universal joint.

As shown in FIG. 16, the drive power transmission to hydraulic pump P may be achieved through a belt 133 by pulley 132 fixed on flywheel 54. In this regard, hydraulic pump P is arranged below and behind internal combustion engine E while pump shaft 130 is projected horizontally rearward, and hydraulic pump P is detachably fixed through pump housing 129 to a support member 134 fixed on vehicle frame 3. A pulley 135 is fixed on the tip portion of pump shaft 130. Belt 133 is provided between pulley 135 and pulley 132 attached through an attachment board 136 to flywheel 54 at the rear end side of internal combustion engine E, whereby the driving force of internal combustion engine E is transmitted to hydraulic pump P.

Power transmission mechanism 125 mostly has the same construction as that of power transmission mechanism 60 according to the first embodiment. However, since the drive transmission train to hydraulic pump P (traveling drive train) is omitted, only a pulley 126a is fixed through electromagnetic clutch 66 on a tip of a lower end portion of an output shaft 126.

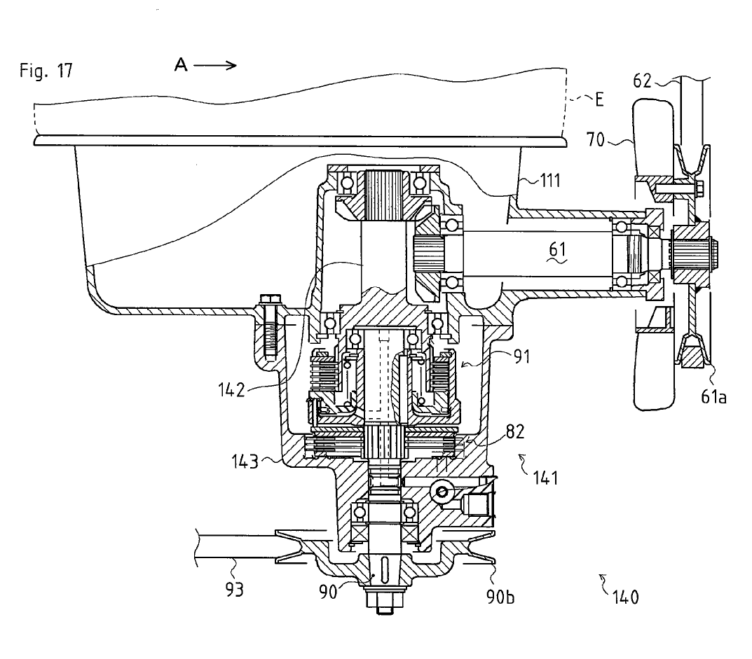

Power transmission mechanism 140 and internal combustion engine E according to the twelfth embodiment comprising it will now be described with reference to FIG. 17. Components and portions having the same functions as those of power transmission mechanisms of the first through eleventh embodiments are designated by the same reference numerals. In FIG. 17, it is assumed that arrow A is directed forward, and the left and right directions are defined on this assumption.

Though not shown in FIG. 17, the structure shown in FIGS. 15 and 16 where hydraulic pump P (traveling drive train) is driven at the flywheel 54 side is adopted to internal combustion engine E of the twelfth embodiment comprising power transmission mechanism 140. Accordingly, no output member to the traveling drive train is provided in power transmission mechanism 140, similarly to power transmission mechanism 125.

Compared with power transmission mechanism 125, power transmission mechanism 140 has a distinct construction in that a hydraulic type working clutch (hydraulic clutch) is interposed in the power transmission to the working device drive train. With regard to the hydraulic clutch, pulley 87a below output shaft 63 shown in the third embodiment (see FIG. 6) is removed, and an output shaft 142 constructed by forming output shaft 63 and clutch input shaft 87 integrally is provided, so as to constitute power transmission mechanism 140 of the present embodiment.

As mentioned above, compared with the third embodiment, power transmission mechanism 140 has a distinct construction in that the drive transmission train to hydraulic pump P (traveling drive train) is omitted. Due to the omission of pulley 87a, the position of a hydraulic clutch unit 141 is shifted upward. Then, as shown in the third embodiment, hydraulic clutch unit 141 has the main body serving as clutch casing 143, which is detachably fixed at the upper end thereof to the lower surface of the oil pan without any support member on the lower surface of the oil pan. Accordingly, PTO shaft 90 is fixed and held stably against the lateral load caused by the tension of belt 93.

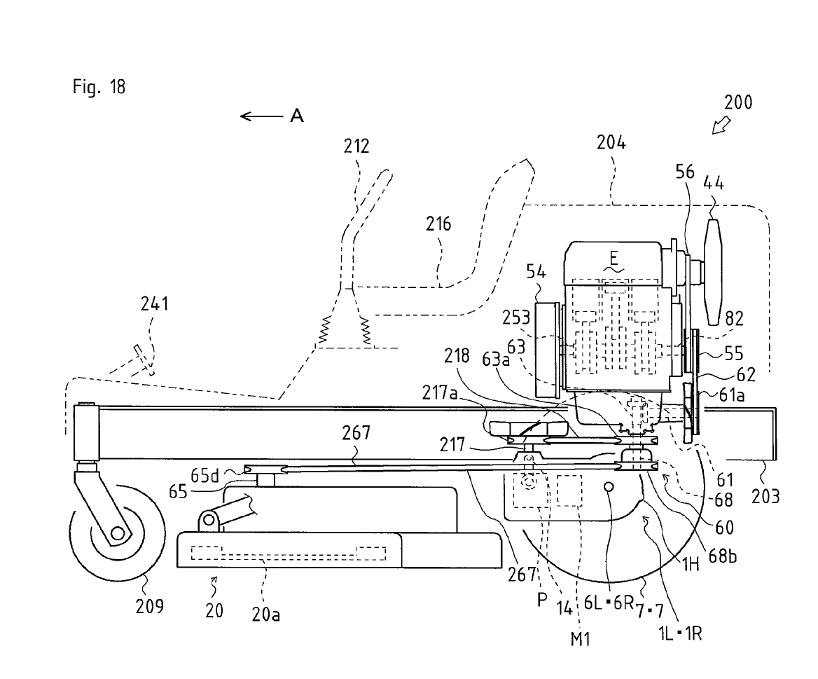

As embodiments of a working vehicle equipped with internal combustion engine E supporting the vertical output shaft in the oil pan, constructions of working vehicles (mower tractor) 200, 300 and 400 will now be described with reference to FIGS. 18 through 20. Components and portions having the same functions as those of the vehicle of the first through eleventh embodiments are designated by the same reference numerals. In FIGS. 18 through 20, it is assumed that arrow A is directed forward, and the left and right directions are defined on this assumption. The direction of internal combustion engine E of the present invention is not limited to those of the present embodiments. The arrangement direction of flywheel 54 may be reversed. When the vehicle body is constructed with a wide frame, internal combustion engine E may be disposed so as to arrange the axis of the crankshaft along the crosswise direction of the vehicle.

The construction of ZTR (Zero-Turn-Radius) vehicle 200 will now be described with reference to FIG. 18. Vehicle 200 has the substantially same construction as that of vehicle 100, that is, hydraulic pump P is integrally housed in rear transaxle 1. Vehicle 200 has a distinct construction in that the front wheels are free wheels (casters) and the drive source is provided to only the rear wheels.

In this regard, vehicle 200 comprises a vehicle frame 203, rear transaxles 1R and 1L supported by the rear portion of vehicle frame 203, casters 209 supported by the front portion of vehicle frame 203, internal combustion engine E supported by vehicle frame 203, mower 20 (an example of the working device driven by internal combustion engine E) vertically and movably suspended downward from vehicle frame 203, and other components.

A rear cover 204, in which internal combustion engine E and the like are housed, is provided above the rear portion of vehicle frame 203. A driver's seat 216 is arranged just before rear cover 204. A pair of left and right operation levers 212 are disposed at the left and right sides of driver's seat 216. Operation levers 212 are interlockingly connected respectively to housings 1H of later-discussed rear transaxles 1R and 1L.

A variable capacity type hydraulic pump P, hydraulic motor M1 serving as a hydraulic motor fluidly connected to hydraulic pump P, one rear wheel axle 6, and a reduction gear train (not shown) drivingly interposed between hydraulic motor M1 and rear wheel axle 6, are housed in each of housings 1H of the pair of right and left rear transaxles 1R and 1L. Each of rear transaxles 1R and 1L adjusts the speed and direction of output rotation of the HST housed in housing 1H corresponding to the angle and direction of tilt of operation lever 212 and speed control lever 14 so as to control the speed of rear wheel axle 6 and to determine either forward or backward rotation direction of rear wheel axle 6. Operation levers 212 are adapted to have a difference in their tilt angle and direction so as to make a difference of right and left rear transaxles 1R and 1L in the output rotary speed and direction, thereby causing differential rotation of right and left rear wheel axles 6 for turning working vehicle 200 right or left. When one of operation levers 212 is tilted to a position causing a forward traveling speed and the other operation lever 212 is tilted to a position causing a backward traveling speed equal to the forward traveling speed, working vehicle 200 turns pivotally centering on the tread center between left and right driving wheels 7.

A brake pedal 241 common to right and left rear transaxles 1R and 1L is provided above vehicle frame 203, before driver's seat 216. A brake is provided in each of rear transaxles 1 so as to brake each of axles 6. As mentioned above, a brake arm (not shown) is pivoted in housing 1H of each of rear transaxles 1 so as to operate the brake. The brake arms of rear transaxles 1R and 1L are interlockingly connected to common brake pedal 241, and by depressing brake pedal 241, both the brake arms are operated to the brake actuation direction simultaneously.

Working vehicle 200 comprises vehicle frame 203 having a pair of left and right side plate portions longitudinally extended. Internal combustion engine E whose direction is opposite to that of working vehicle 100 in FIG. 1 is supported through vibro-isolating rubber on the rear portion of vehicle frame 203. In this regard, a front crankshaft 253 projecting forward is provided on the front end surface of internal combustion engine E, and flywheel 54 is fixed on the tip portion of front crankshaft 253. A horizontal rear crankshaft 282 is provided on the rear end surface of internal combustion engine E, and doubled pulleys 55 are fixed on the tip portion of rear crankshaft 282.

Mower 20 is vertically movably suspended downward from vehicle frame 203 before rear transaxles 1R and 1L. Mower 20 comprises rotary blades 20a for mowing. Vertical input shaft 65 for driving rotary blades 20a projects from the upper portion of mower 20, and pulley 65a is fixed on the tip portion of input shaft 65.

One side pulley of doubled pulleys 55 disposed on rear crankshaft end 82 is connected through belt 56 to radiator fan 44 above rear crankshaft end 82. The other side pulley of doubled pulleys 55 is drivingly connected through belt 62 to pulley 61a fixed on the tip portion of input shaft 61. The power of internal combustion engine E outputted through input shaft 61 is transmitted to mower 20 and hydraulic pumps P of rear transaxles 1R and 1L through coaxial output shaft 63 and PTO shaft 68 extending vertically downward from the lower portion of internal combustion engine E.

In this regard, pulley 63a fixed on output shaft 63 is drivingly connected through a belt 218 to a pulley 217a fixed on an input shaft 217 of each of hydraulic pumps P. Pulley 68b arranged through electromagnetic clutch 66 on PTO shaft 68 is drivingly connected through electromagnetic clutch 66 and a belt 267 to pulley 65a on input shaft 65 projecting from the upper end of mower 20. In other words, by operating electromagnetic clutch 66, the power transmission to mower 20 is switched on or off.

Similarly to vehicle 100, with regard to vehicle 200 of the present invention, any one of the power transmission mechanisms of internal combustion engines E according to the first through twelfth embodiments may be adopted as the power transmission mechanism provided below internal combustion engine E, if possible. Alternatively, to constitute rear transaxles 1R and 1L, a pair of hydraulic motors, which are so-called wheel motors, may be provided coaxially or adjacently to respective rear wheel axles 6L and 6R in rims of respective rear wheels, and a pair of hydraulic pumps to be fluidly connected to the respective hydraulic motors may be disposed independently of the respective wheel motors. The pair of hydraulic pumps may be unified as a dual pump unit as shown in U.S. Pat. No. 6,425,244, or a tandem pump unit as shown in U.S. Pat. No. 6,487,856, and the unit may be driven by the power taking-off mechanism on the flywheel side shown in FIGS. 15 and 16.

The construction of vehicle 300 will now be described with reference to FIG. 19. Vehicle 300 differs widely from vehicle 100 in that hydraulic pump P is arranged separately outside rear transaxle 1. Vehicle 300 has substantially the same construction as that of vehicle 100 in other points.

In this regard, similarly to vehicle 100, vehicle 300 of the present embodiment is an Ackerman-type steering lawn mower and comprises a vehicle frame 303, a rear transaxle 301 supported in the rear portion of vehicle frame 303, front transaxle 2 supported in the front portion of vehicle frame 303, engine E supported on vehicle frame 303 between rear transaxle 301 and front transaxle 2, a pump housing 311 supported on vehicle frame 303, a mower 20 (an example of the working device driven by internal combustion engine E) vertically movably suspended downward from vehicle frame 303, and other components.

A hydraulic motor M1 is housed in rear transaxle 301, and a pair of left and right hydraulic motors M2 and M3 are housed in front transaxle 2. Hydraulic motors M1, M2 and M3 are fluidly drivingly connected through piping to hydraulic pump P in pump housing 311 independent of rear transaxle 301.

A grass accumulation device is optionally connected to the rear end portion of vehicle 300, and a transfer duct D is interposed between the grass accumulation device and mower 20, between driving wheels 7. The front opening of transfer duct D is connected with the rear portion of mower 20, and the rear opening of transfer duct D is connected with the grass accumulation device through an exhaust port provided in a rear wall 304b of a rear cover 304 disposed on the rear portion of vehicle frame 303, whereby grass mowed by mower 20 is sucked into the transfer duct and blown to the grass accumulation device.

The rear part of vehicle frame 303 rearward from the substantial center thereof is extended rearwardly upward in conformance with the shape of transfer duct D. Rear transaxle 301 is disposed in the center of vehicle frame 303, and output shafts 301a extended from rear transaxle 301 through a differential unit (not shown) are drivingly connected respectively to left and right rear wheel axles 6 through chain units 19. Accordingly, with regard to vehicle 300, a sufficiently large space is secured below the lower portion of vehicle frame 303, whereby transfer duct D has a sufficient ability of releasing grass at the left and right sides of the rear portion of vehicle 300 while gradually expanding the opening area thereof rearward.

Similarly to vehicle 100, internal combustion engine E is mounted above the front portion of vehicle frame 303 and disposed at the lateral center between the left and right side plates of vehicle frame 303. Horizontal rear crankshaft end 53 extending rearward is provided on the rear end surface of internal combustion engine E, and flywheel 54 is fixed on the tip portion of rear crankshaft end 53. A fan 315 is fixed on the rear end surface of flywheel 54.

On the other hand, pump housing 311 is not integral with rear transaxle 301, i.e., it is separated from rear transaxle 301, and is disposed behind internal combustion engine E so that pump housing 311 is supported upright on vehicle frame 303 while orienting a pump shaft 317 downward vertically. Accordingly, pump housing 311 is cooled efficiently by fan 315.

One side pulley of doubled pulleys 55 disposed on the tip portion of front crankshaft end 82 is connected through belt 56 to radiator fan 44 above front crankshaft end 82. The other side pulley of doubled pulleys 55 is drivingly connected through belt 62 to pulley 61a fixed on the tip portion of input shaft 61 of internal combustion engine E according to the first embodiment. The power of internal combustion engine E coming from input shaft 61 is transmitted to mower 20 and hydraulic pump P through coaxial output shaft 63 and PTO shaft 68 extending vertically downward from the lower portion of internal combustion engine E.

In this regard, pulley 63a fixed on output shaft 63 is drivingly connected through a belt 318 to a pulley 317a fixed on pump shaft 317 of hydraulic pump P, and pulley 68b arranged through electromagnetic clutch 66 on PTO shaft 68 is drivingly connected through electromagnetic clutch 66 and a belt 67 to pulley 65a on input shaft 65 projecting from the upper end of mower 20. Namely, by operating electromagnetic clutch 66, the power transmission to mower 20 is switched on or off.

Similarly to vehicle 100 and vehicle 200, with regard to vehicle 300 of the present invention, any one of the power transmission mechanisms of internal combustion engines E according to the first through twelfth embodiments may be adopted as the power transmission mechanism provided below internal combustion engine E, if possible. Another hydraulic pump serving as an additional hydraulic pressure source for a power steering mechanism, e.g., if it is provided as a steering system of front wheels 9, may be driven while employing the mode of the rear surface of flywheel 54 shown in FIG. 15 or 16.

The entire construction of vehicle 400 will now be described with reference to FIG. 20. Similarly to vehicle 300, vehicle 400 differs from vehicle 100 and vehicle 200 in that hydraulic pump P is arranged separately outside rear transaxle 1. Vehicle 400 differs from vehicle 300 in that it has an articulated vehicle frame structure.

In this regard, vehicle 400 comprises a front frame 451 and a rear frame 452 into which the vehicle body is divided at the longitudinal center, a front transaxle 402, a rear transaxle 401, internal combustion engine E supported on rear frame 452 between transaxles 401 and 402, a pump housing 411, mower 20 (an example of the working device driven by internal combustion engine E) vertically movably suspended downward from front frame 451, and others.

The rear end of front frame 451 and the front end of rear frame 452 are rotatably connected to each other through a connection part 450 which usually serves as a pivot point so that rear frame 452 is rotatable relative to front frame 451 around a vertical axis of a connection shaft 455 by steering operation (operation of steering wheel 404).

The lower end portion of connection shaft 455 is extended downward and a lower connection part output pulley 457 and an upper connection part input pulley 456 are rotatably supported on the lower end portion of connection shaft 455 through bearings (not shown).

Internal combustion engine E is mounted on rear frame 452. A steering column 414, steering wheel 404, a foot pedal 415 and the like are disposed on the front portion of front frame 451, and driver's seat 16 is constructed behind steering column 414 on front frame 451. A mower 420 driven by internal combustion engine E is vertically and movably arranged below and before driver's seat 16, at the outer side end of front frame 451.

Internal combustion engine E covered by a bonnet 408 is disposed on rear frame 452, and rear transaxle 401 is disposed below internal combustion engine E.

Hydraulic motor M1 is integrally provided in each of rear transaxle 401 and front transaxle 402 respectively and drives corresponding front wheel axles 8L and 8R or rear wheel axles 6L and 6R through a reduction gear and a differential (not shown). Rear transaxle 401 and front transaxle 402 are fluidly connected mutually through piping by hydraulic pump P housed in independent pump housing 411. Alternatively, to constitute rear transaxle 401 and front transaxle 402, a pair of hydraulic motors, which are so-called wheel motors, may be provided coaxially or adjacent to respective front wheel axles 8L and 8R or respective rear wheel axles 6L and 6R.

The power transmission structure of vehicle 400 of the present embodiment will now be described. One side pulley of doubled pulleys 55 disposed on rear crankshaft end 482 is connected through belt 56 to radiator fan 44 above front crankshaft end 482. The other side pulley of doubled pulleys 55 is drivingly connected through belt 62 to pulley 61a fixed on the tip portion of input shaft 61 of internal combustion engine E according to the first embodiment. The power of internal combustion engine E coming from input shaft 61 is transmitted to mower 420 and hydraulic pump P through coaxial output shaft 63 and PTO shaft 68 extended vertically downward from the lower portion of internal combustion engine E.

In this regard, pulley 63a fixed on output shaft 63 is drivingly connected through a belt 418 to a pulley 417a fixed on a pump shaft 417 of hydraulic pump P. The power from and pulley 68b arranged through electromagnetic clutch 66 on PTO shaft 68 is transmitted through a belt 458 to connection part input pulley 456 fixed on the lower end portion of connection shaft 455. Connection part output pulley 457 rotated integrally with output pulley 68b is drivingly connected through electromagnetic clutch 66 and a belt 467 to pulley 65a on input shaft 65 projecting from the upper end of mower 20. Accordingly, by operating electromagnetic clutch 66, the power transmission to mower 20 is switched on or off. Since belt 458 is not moved vertically at the time of the vertical movement of mower 20 compared with belt 467, belt 458 can be provided with a tension clutch instead of electromagnetic clutch 66.

Similarly to vehicle 100, vehicle 200 and vehicle 300, with regard to vehicle 400 of the present invention, any one of the power transmission mechanisms of internal combustion engines E according to the first through twelfth embodiments may be adopted as the power transmission mechanism provided below internal combustion engine E, if possible.

In addition to the above-mentioned riding lawn mower, a riding snow blower and a refuse cart are given as examples of the vehicle on which the working device having the vertical input shaft could be mounted.

It is further understood by those skilled in the art that the foregoing description is a preferred embodiment of the disclosed device and that various changes and modifications may be made in the invention without departing from the scope thereof defined by the following claims.

What is claimed is:

1. An internal combustion engine comprising:
a crankshaft;
an oil pan; and
an output shaft supported by the oil pan, wherein the output shaft is disposed perpendicular to the crankshaft, and is drivingly connected to the crankshaft.

2. The internal combustion engine according to claim 1, wherein the output shaft is disposed within a plane of projection of the internal combustion engine when viewed in plan.

3. The internal combustion engine according to claim 1, further comprising:
a housing provided in the oil pan so as to incorporate the output shaft.

4. The internal combustion engine according to claim 1, further comprising:
an input shaft for transmitting power from the crankshaft to the output shaft, wherein the input shaft is disposed parallel to the crankshaft, and is drivingly connected to the output shaft in the oil pan.

5. The internal combustion engine according to claim 4, wherein the input shaft includes a portion projecting outward from the oil pan such as to be drivingly connected to the crankshaft.

6. The internal combustion engine according to claim 5, further comprising:
a cooling fan provided on the projecting portion of the input shaft.

7. The internal combustion engine according to claim 4, further comprising:
an endless band transmission for drivingly connecting the input shaft to the crankshaft.

8. The internal combustion engine according to claim 4, further comprising:
a housing provided in the oil pan so as to incorporate the output shaft, wherein the input shaft is inserted into the housing so as to be drivingly connected to the output shaft.

9. The internal combustion engine according to claim 1, further comprising:
a first gear provided on the crankshaft; and
a second gear provided on the output shaft so as to mesh with the first gear.

10. The internal combustion engine according to claim 1, further comprising:
an output member for outputting power of the output shaft to a drive target, wherein the output member is provided on a portion of the output shaft outward from the oil pan.

11. The internal combustion engine according to claim 10, further comprising:
a clutch interposed between the output member and the output shaft.

12. The internal combustion engine according to claim 10, further comprising:
a second output shaft receiving power from the foresaid output shaft; and
a second output member provided on the second output shaft so as to receive power from the foresaid output member.

13. The internal combustion engine according to claim 12, further comprising:
a clutch interposed between the second output shaft and the second output member.

14. The internal combustion engine according to claim 1, wherein the output shaft includes a portion projecting outward from the oil pan, the internal combustion engine further comprising:
first and second output members are provided on the projecting portion of the output shaft so as to distribute power from the output shaft to respective drive targets.

15. The internal combustion engine according to claim 14, further comprising:
a clutch interposed between the output shaft and at least one of the first and second output members.

16. A vehicle power transmission system comprising:
an internal combustion engine including an oil pan, wherein the internal combustion engine is mounted on the vehicle so as to have a substantially horizontal crankshaft; and
a rotary member for transmitting power from the crankshaft to a drive target, wherein the rotary member is supported by the oil pan rotatably centered on a vertical axis, and is drivingly connected to the crankshaft.

17. The vehicle power transmission system according to claim 16, the rotary member including:
a first output member drivingly connected to a first drive target; and
a second output member drivingly connected to a second drive target.

18. The vehicle power transmission system according to claim 16, further comprising:
a flywheel of the internal combustion engine, wherein the flywheel is provided on an end portion of the crankshaft; and
a second rotary member provided on the flywheel, wherein the foresaid rotary member supported by the oil pan is drivingly connected to a first drive target, and wherein the second rotary member is drivingly connected to a second drive target.

19. A lawn tractor comprising:
a mower;
a transaxle;
a vehicle frame;
an internal combustion engine including an oil pan, wherein the internal combustion engine is mounted on the vehicle frame so as to have a substantially horizontal crankshaft; and
a rotary member for transmitting power from the crankshaft to the mower or the transaxle, wherein the rotary member is supported by the oil pan rotatably centered on a vertical axis, and is drivingly connected to the crankshaft.

20. The lawn tractor according to claim 19, the rotary member including:
a first output member drivingly connected to the transaxle; and
a second output member drivingly connected to the mower.

21. The lawn tractor according to claim 19, further comprising:
a flywheel of the internal combustion engine, wherein the flywheel is provided on an end portion of the crankshaft; and
a second rotary member provided on the flywheel, wherein the foresaid rotary member supported by the oil pan is drivingly connected to one of the mower and the transaxle, and wherein the second rotary member is drivingly connected to the other of the mower and the transaxle.
